(19) United States
(12) Patent Application Publication
(10) Pub. No.: US 2013/0226957 A1
(43) Pub. Date: Aug. 29, 2013

(54) Methods, Systems, and Media for Identifying Similar Songs Using Two-Dimensional Fourier Transform Magnitudes

(71) Applicant: The Trustees of Columbia University in the City of New York, (US)

(72) Inventors: Daniel P.W. Ellis, New York, NY (US); Thierry Bertin-Mahieux, New York, NY (US)

(73) Assignee: The Trustees of Columbia University in the City of New York, New York, NY (US)

(21) Appl. No.: 13/779,594

(22) Filed: Feb. 27, 2013

Related U.S. Application Data
(60) Provisional application No. 61/603,472, filed on Feb. 27, 2012.

(51) Int. Cl. G06F 17/30

(52) U.S. Cl. CPC G06F 17/30026
USPC 707/769

(57) ABSTRACT

Methods, systems, and media for identifying cover songs using two-dimensional Fourier transform magnitudes are provided. In some embodiments, methods for identifying a cover song from a query song are provided, the methods comprising: identifying a query song vector for the query song, wherein the query song vector is indicative of a two-dimensional Fourier transform based on the query song; identifying a plurality of reference song vectors that each correspond to one of a plurality of reference songs, wherein each of the plurality of reference song vectors is indicative of a two-dimensional Fourier transform created based on the corresponding reference song; determining a distance between the query song vector and each of the plurality of reference song vectors; generating an indication that a reference song corresponding to a reference song vector with a shortest distance to the query song vector is a similar song to the query song.

### CROSS-REFERENCE TO RELATED APPLICATION

This application claims the benefit of U.S. Provisional Patent Application No. 61/603,472, filed Feb. 27, 2012, which is hereby incorporated by reference herein in its entirety.

### STATEMENT REGARDING FEDERALLY SPONSORED RESEARCH OR DEVELOPMENT

This invention was made with government support under Award No. IIS-0713334 awarded by the National Science Foundation (NSF). The government has certain rights in the invention.

### TECHNICAL FIELD

The disclosed subject matter relates to methods, systems, and media for identifying similar songs using two-dimensional Fourier transform magnitudes.

### BACKGROUND

The capability to automatically identify similar songs is a capability with many applications. For example, a music lover may desire to identify cover versions of a song in order to enjoy other interpretations of that song. As another example, copyright holders may want to be able to identify different versions of their songs, copies of their songs, etc., in order to insure proper copyright license revenue. As yet another example, users may want to be able to identify songs with similar sound to a particular song. As still another example, a user listening to a particular song may desire to know the identity of the song or artist performing the song.

While it is generally easy for a human, to identify two songs that are similar, automatically doing so with a machine is much more difficult. For example, the two songs can be played in a different key, such that conventional fingerprinting is not accurate. As another example, the two songs can be played at different tempos. As yet another example, a performer playing a cover version may add, remove or rearrange parts of the song. All of this can make it hard to identify a cover version of a song. With millions of songs readily available, having humans compare songs manually is practically impossible. Therefore, there is a need for mechanisms that can automatically identify similar songs.

### SUMMARY

Methods, systems, and media for identifying similar songs using two-dimensional Fourier transform magnitudes are provided. In accordance with some embodiments of the disclosed subject matter, methods for identifying a cover song from a query song are provided, the methods comprising: identifying, using at least one hardware processor, a query song vector for the query song, wherein the query song vector is indicative of a two-dimensional Fourier transform based on the query song; identifying a plurality of reference song vectors that each correspond to one of a plurality of reference songs, wherein each of the plurality of reference song vectors is indicative of a two-dimensional Fourier transform created based on the corresponding reference song; determining a distance between the query song vector and each of the plurality of reference song vectors; generating an indication that a reference song corresponding to a reference song vector with a shortest distance to the query song vector is a similar song to the query song.

In some embodiments, identifying a vector further comprises; generating a beat-synchronized chroma matrix of a plurality of chroma vectors each having a plurality of chroma bins for a portion of a song; generating one or more two-dimensional. Fourier transform, patches based on the beat-synchronized chroma matrix; calculating one or more principal components using a principal component analysis based on the one or more two-dimensional Fourier transform patches; and calculating the vector based on values of the one or more principal components.

In some embodiments, the method further comprises raising a value in each of the chroma bins by an exponent.

In some embodiments, the exponent is chosen from a range of 0.25 to 3.

In some embodiments, each of the one or more two-dimensional Fourier transform patches is based on a patch of the beat-synchronized chroma matrix of a particular length.

In some embodiments, the beat-synchronized chroma matrix patch has a size defined by the particular length and the number of chroma bins in each chroma vector and has a total number of chroma bins equal to the particular length times the number of chroma bins in each chroma vector, and wherein the two-dimensional Fourier transform patch has a number of components equal to the number of chroma bins in the beat-synchronized chroma patch and is the same size as the beat-synchronized chroma matrix patch upon which it is based.

In some embodiments, the method further comprises: determining magnitude components of the one or more two-dimensional Fourier transform patches and generating two-dimensional Fourier transform magnitude patches based on the magnitudes; generating a median two-dimensional Fourier transform magnitude patch based on a median of the magnitude components at each position in the two-dimensional Fourier transform magnitude patches; and wherein the principal component analysis is performed based on values of the median two-dimensional Fourier transform magnitude patch.

In some embodiments, the vector is based on a subset of the calculated principal components.

In some embodiments, the vector is based on a predetermined number of the first principal, components, wherein the predetermined number is chosen from a range often to two hundred principal components.

In some embodiments, the distance is a Euclidian distance.

In some embodiments, identifying a vector further comprises receiving a vector from a server.

In accordance with some embodiments of the disclosed subject matter, systems

for identifying a similar song from a query song are provided, the systems comprising: a hardware processor configured to: identify a query song vector for the query song, wherein the query song vector is indicative of a two-dimensional Fourier transform based on the query song; identify a plurality of reference song vectors that each correspond to one of a plurality of reference songs, wherein each of the plurality of reference song vectors is indicative of a two-dimensional Fourier transform created based on the corresponding reference song; determine a distance between the query song vector and each of the plurality of reference song vectors; generate an indication that a reference song corresponding to a reference song vector with a shortest distance to the query song vector is a similar song to the query song.

In accordance with some embodiments of the disclosed subject matter, non-transitory computer-readable media containing computer executable instructions that, when executed by a processor, cause the processor to perform a method for identifying a similar song from a query song are provided, the methods comprising: identifying a query song vector for the query song, wherein the query song vector is indicative of a two-dimensional Fourier transform based on the query song; identifying a plurality of reference song vectors that each, correspond to one of a plurality of reference songs, wherein each of the plurality of reference song vectors is indicative of a two-dimensional Fourier transform created based on the corresponding reference song; determining a distance between the query song vector and each of the plurality of reference song vectors; generating an indication that a reference song corresponding to a reference song vector with a shortest distance to the query song vector is a similar song to the query song.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 is an example of a diagram of a mechanism for identifying similar songs in accordance with some embodiments of the disclosed subject, matter;

FIG. 2A shows an illustrative process for creating and storing vectors for a reference song(s) in accordance with some embodiments of the disclosed subject matter;

FIG. 2B shows an illustrative process for identifying similar songs using reference song vectors stored in FIG. 2A in accordance with some embodiments of the disclosed subject matter;

FIG. 3 shows an illustrative process for generating a normalized beat-synchronized chroma matrix in accordance with some embodiments of the disclosed subject matter;

FIG. 4 shows an illustrative process for creating a median two-dimensional Fourier transform magnitude patch from a beat-synchronized chroma matrix in accordance with some embodiments of the disclosed subject matter;

FIG. 5A is an example of a diagram showing a beat-aligned chroma patch and a corresponding two-dimensional Fourier transform magnitude patch in accordance with some embodiments of the disclosed subject: matter;

FIG. 5B is an example of a diagram showing two-dimensional Fourier transform magnitude patches for a first patch, a last patch, and a median patch in accordance with some embodiments of the disclosed subject matter;

FIG. 6 shows an illustrative process for generating a vector from a median two-dimensional Fourier transform magnitude patch in accordance with some embodiments of the disclosed subject matter;

FIG. 7A shows a schematic diagram of an illustrative system suitable for implementation of an application for identifying similar songs using two-dimensional Fourier transform magnitudes in accordance with some embodiments of the disclosed subject matter;

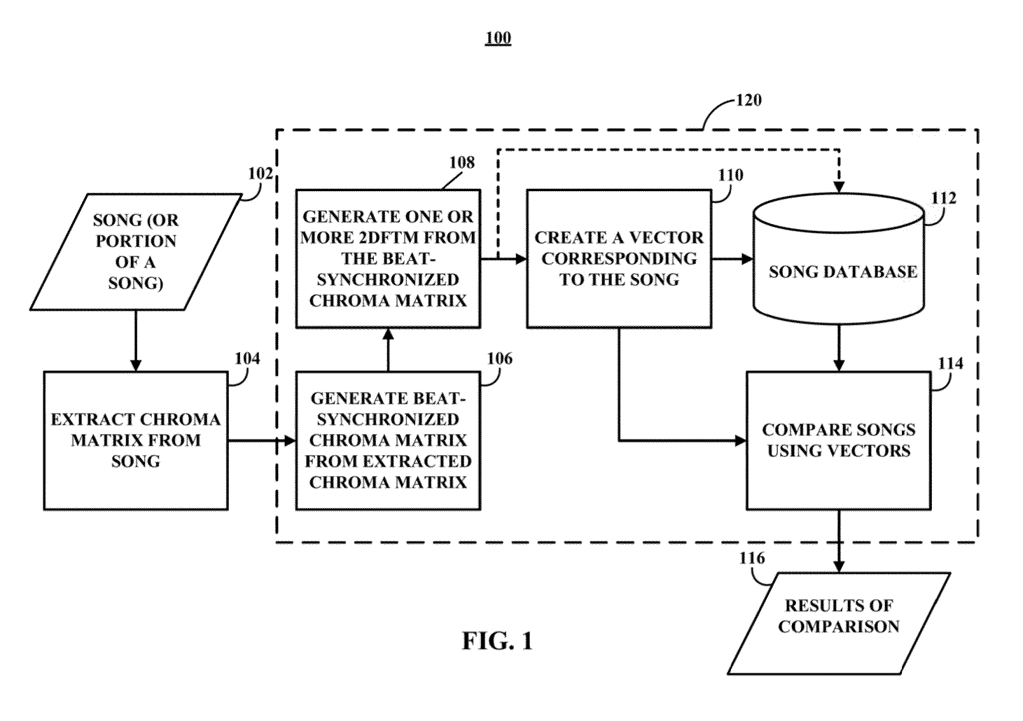

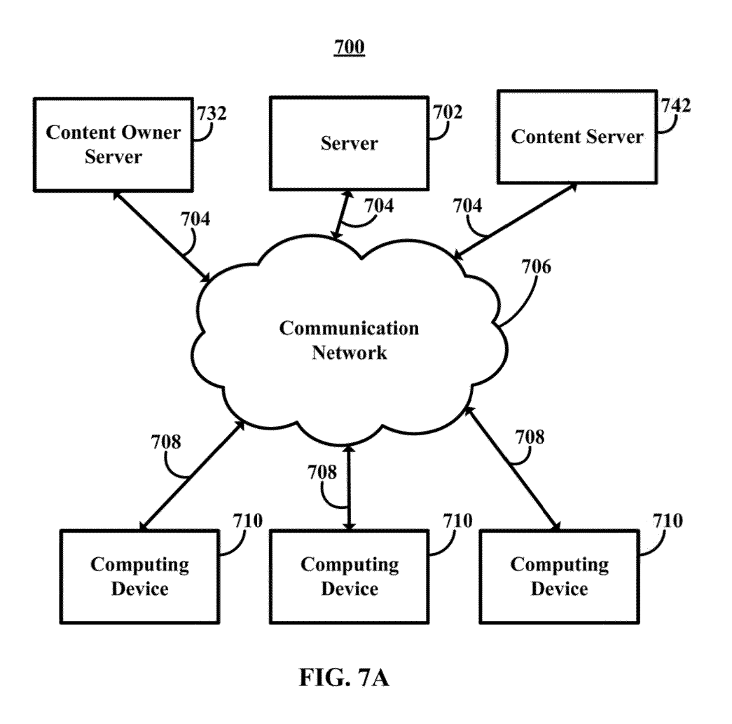

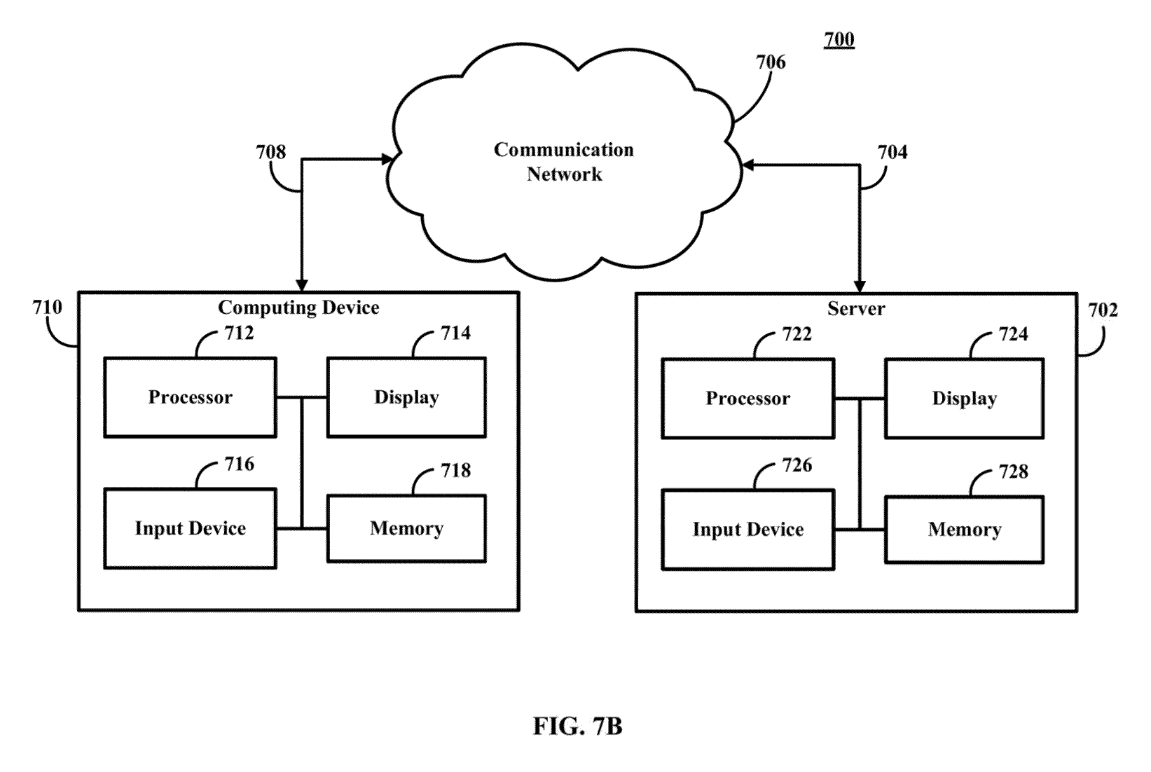

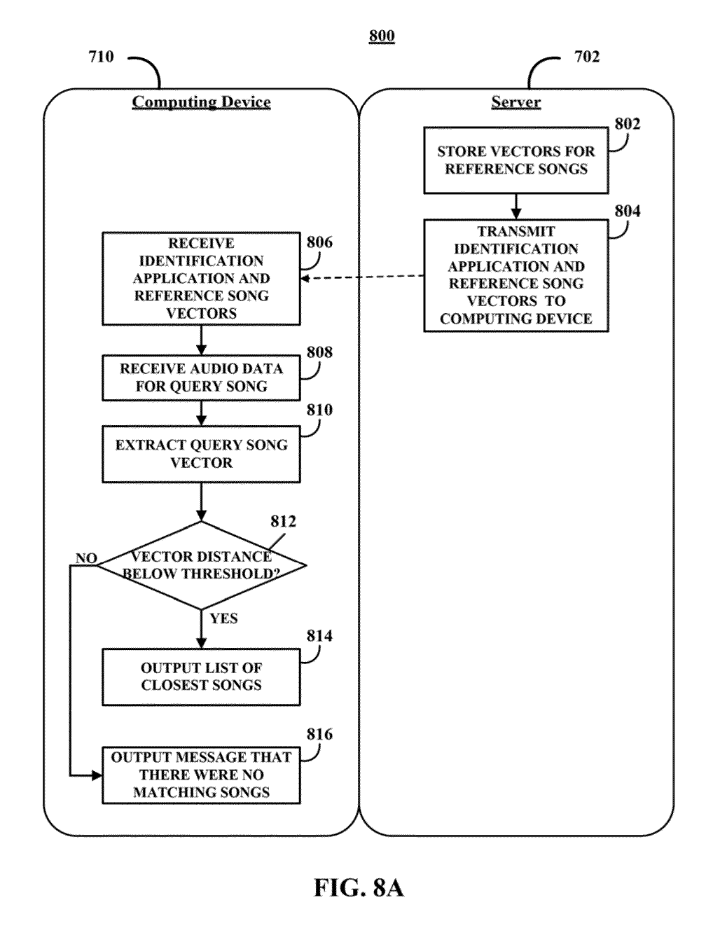

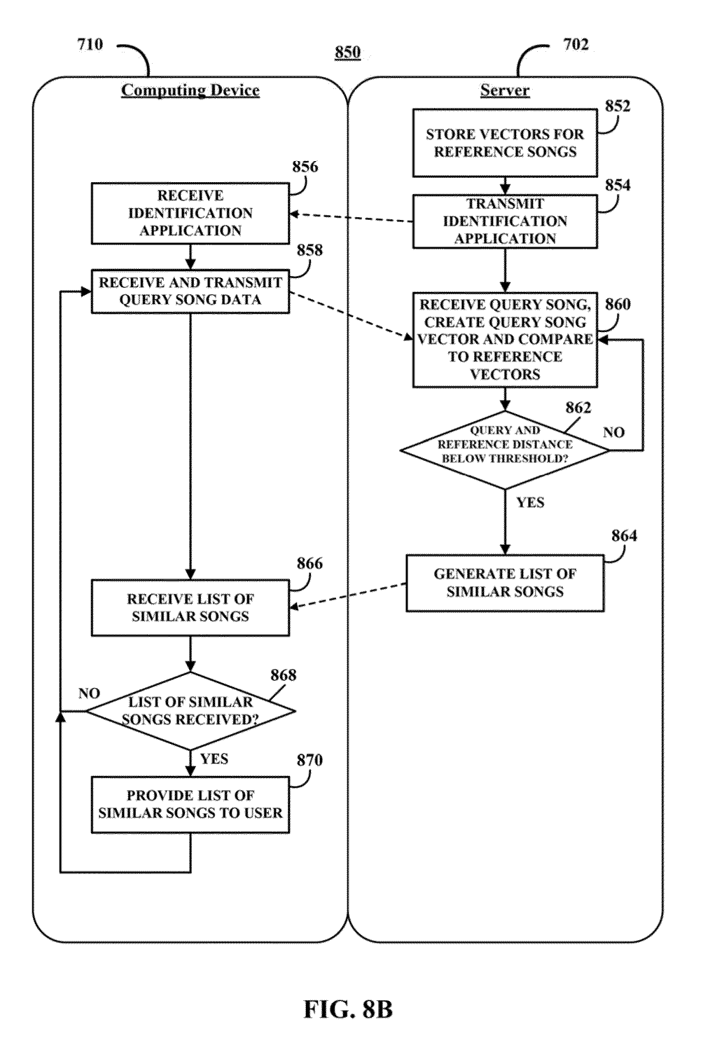

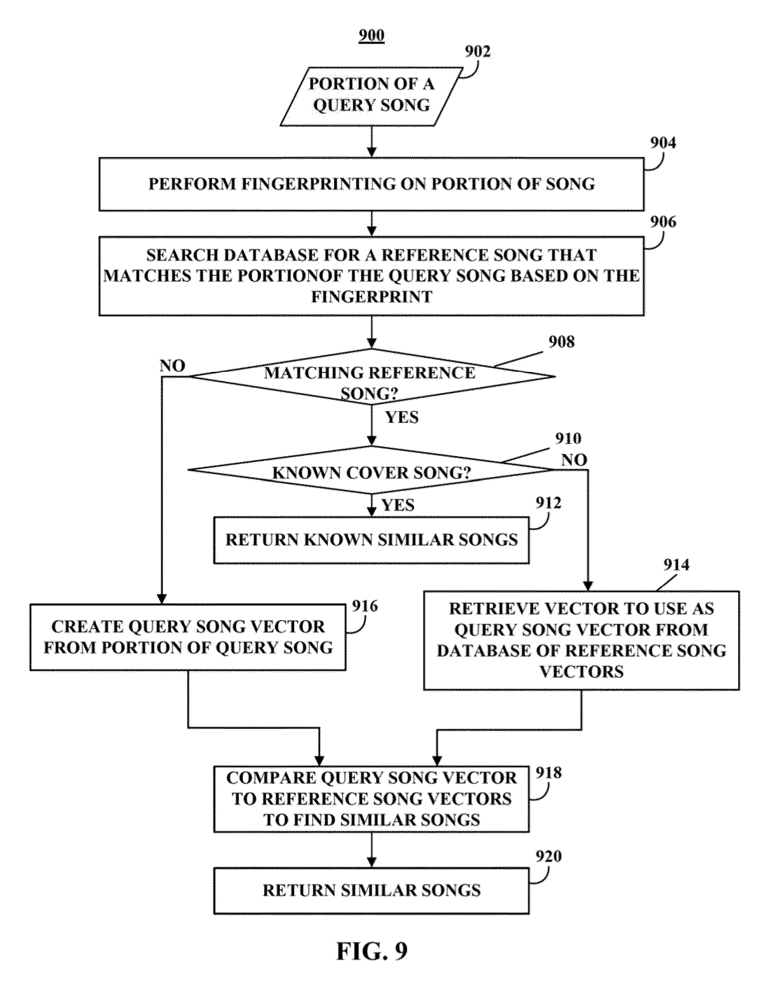

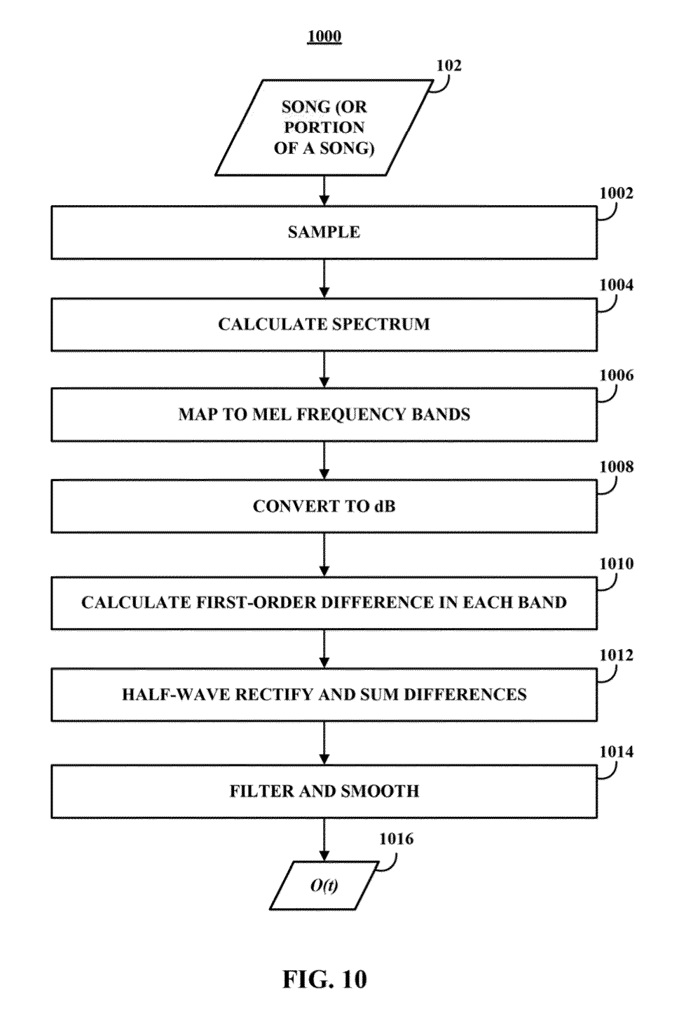

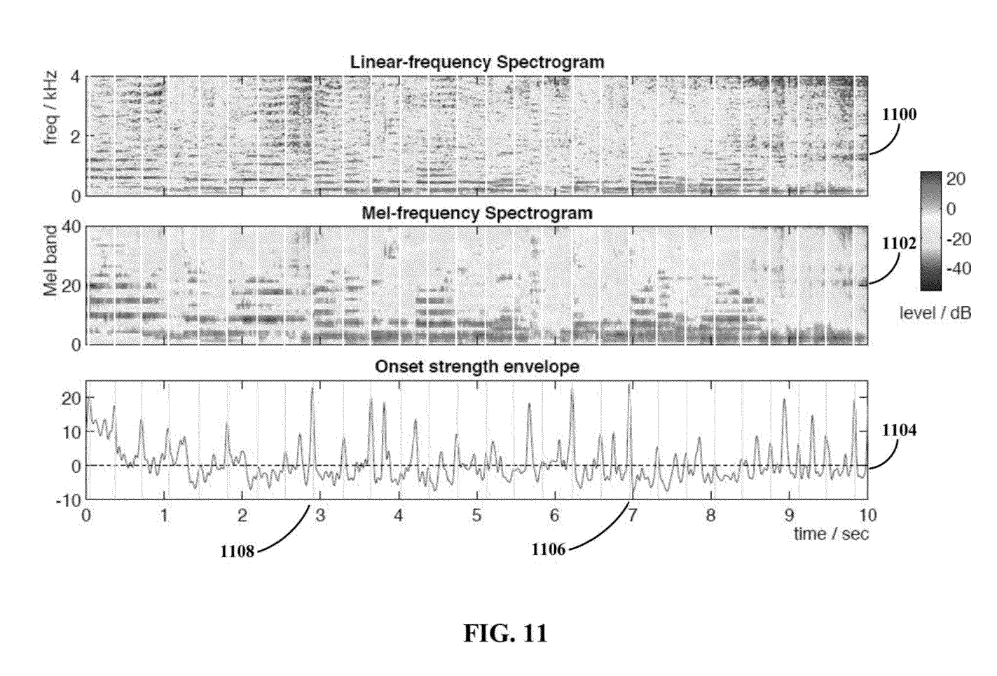

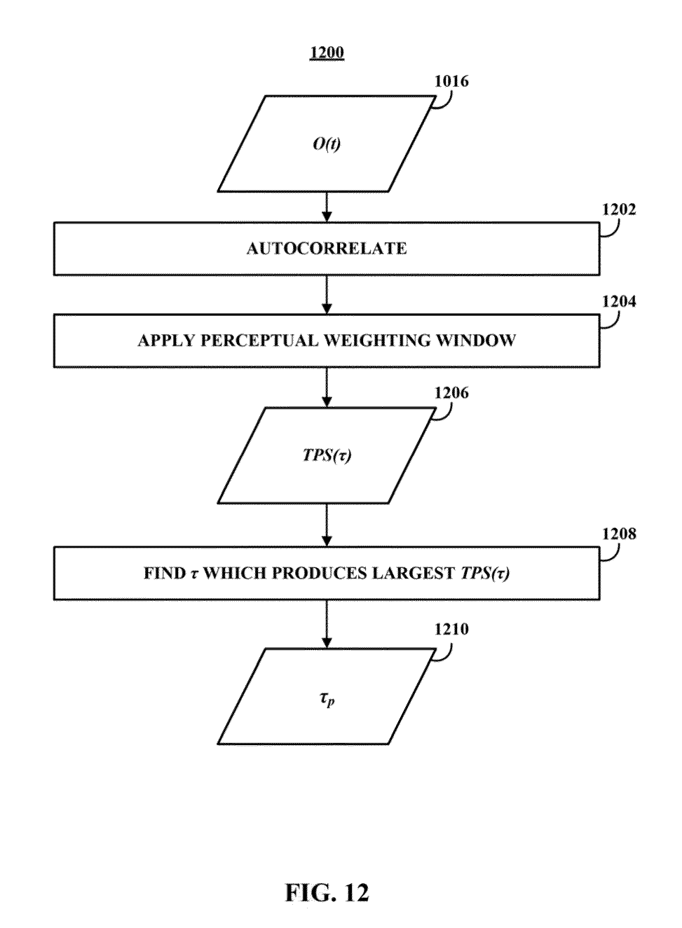

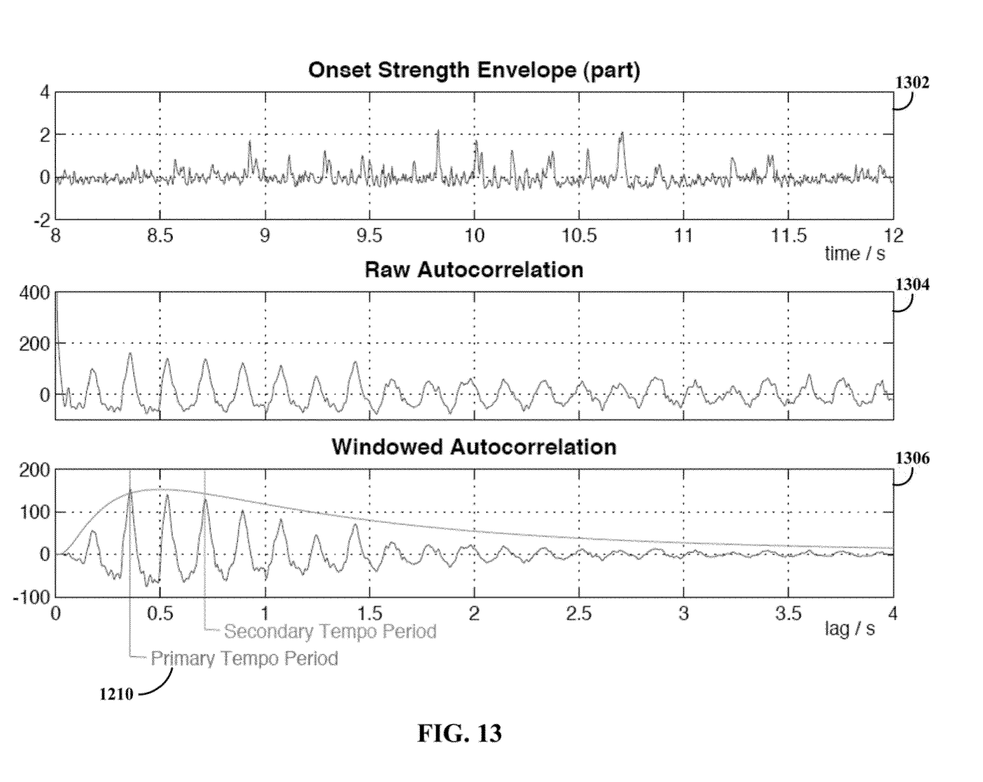

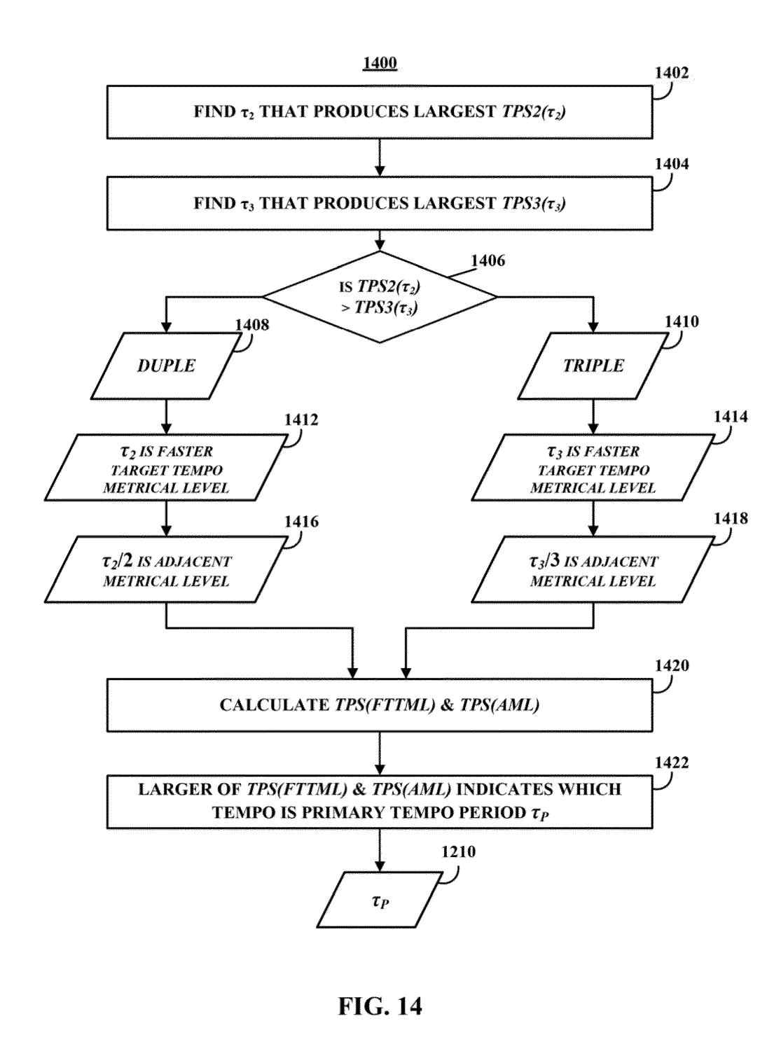

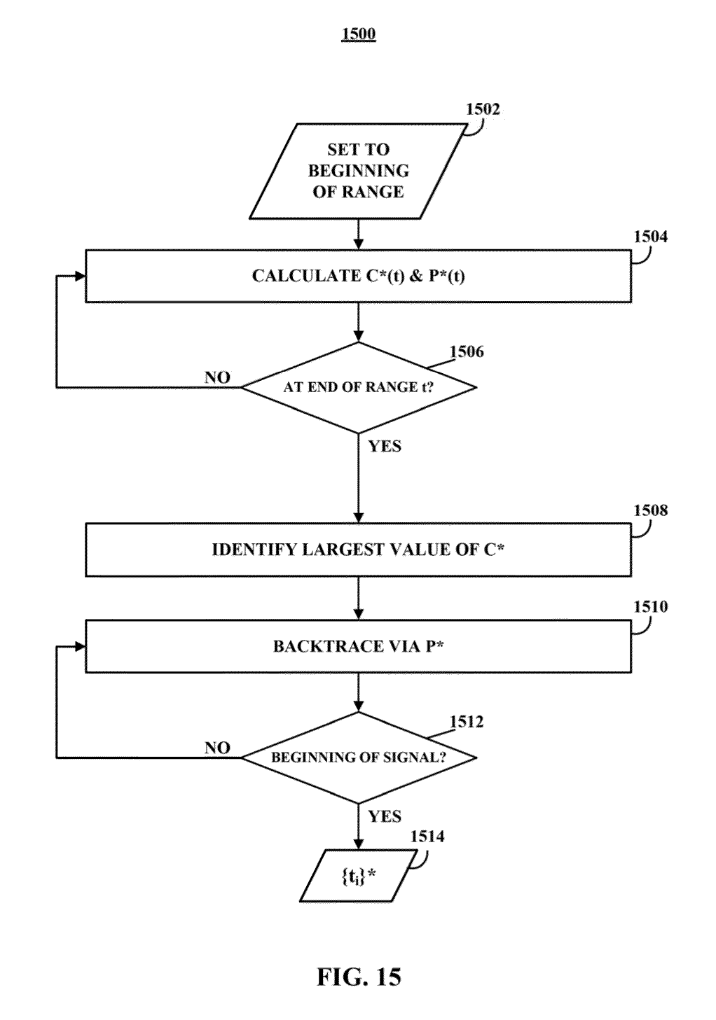

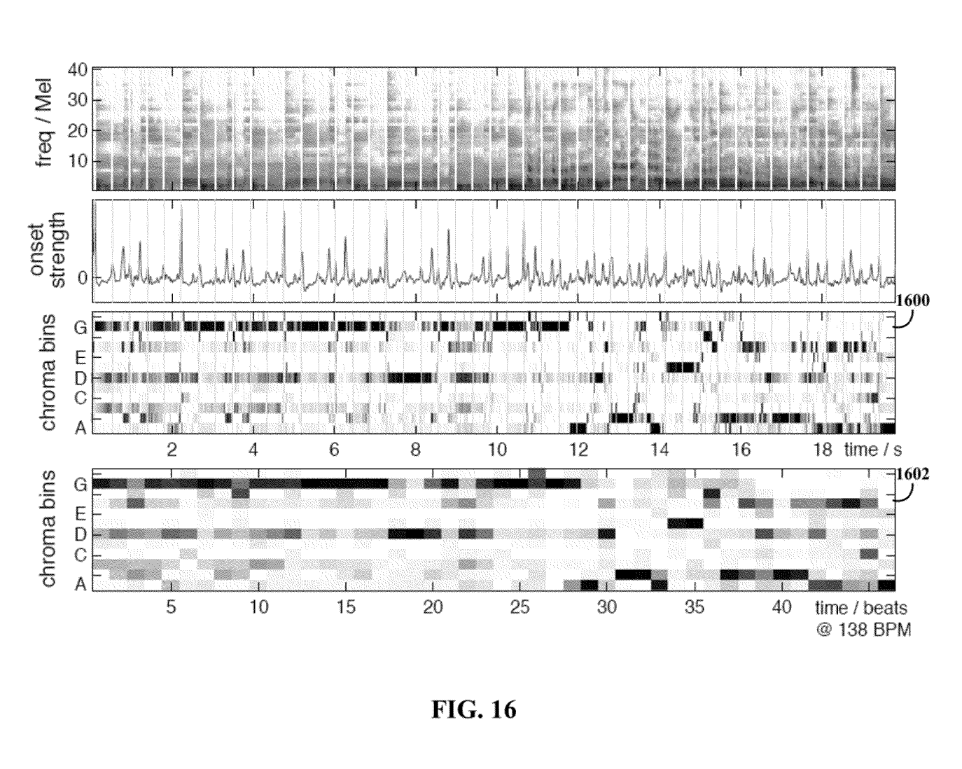

FIG. 1B shows a detailed example of the server and one of the computing devices of FIG. 7A that can be used in accordance with some embodiments of the disclosed subject matter;

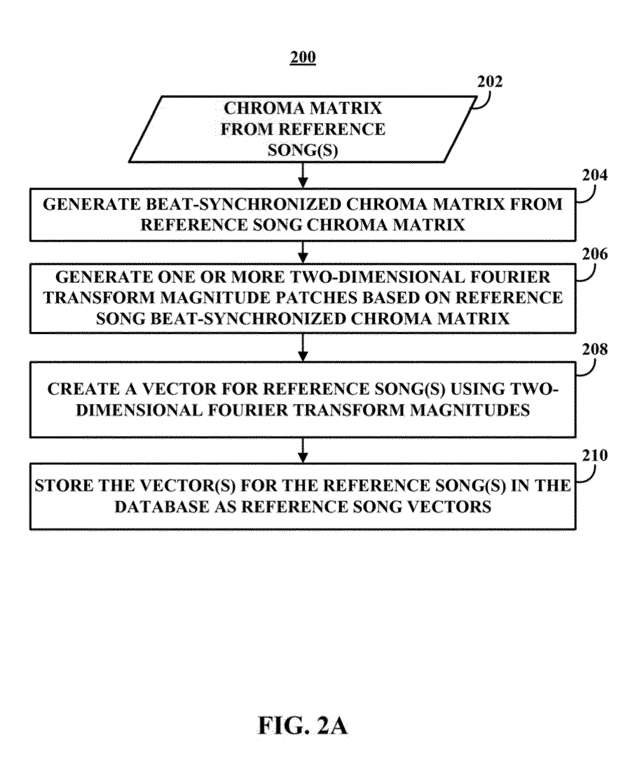

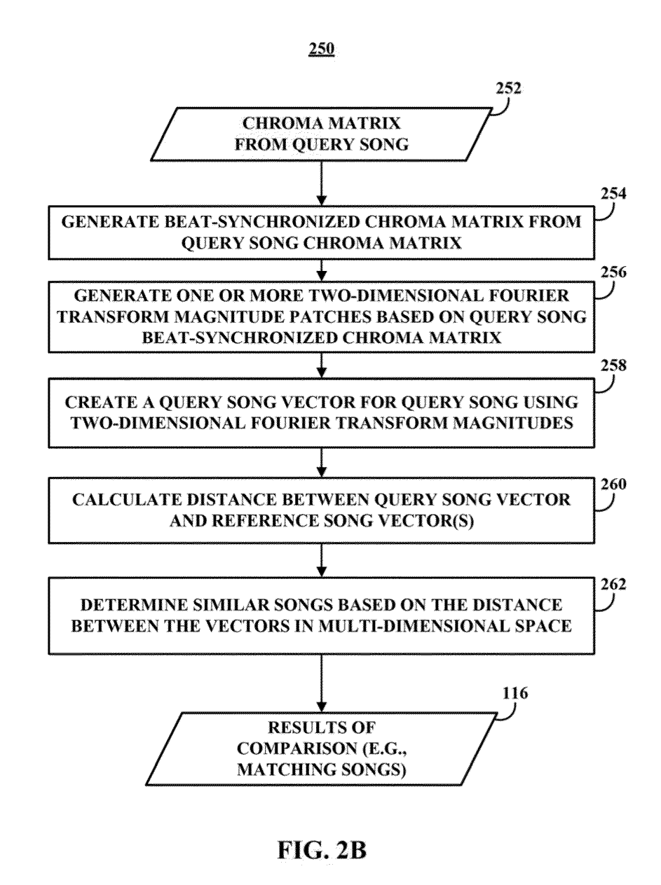

FIG. 8A shows a diagram illustrating an example of a data flow used with the process of FIGS. 2A and 2B in accordance with some embodiments of the disclosed subject matter;

FIG. 8B shows another diagram illustrating an example of a data flow used in the process of FIGS. 2A and 2B in accordance with some embodiments of the disclosed subject matter;

FIG. 9 shows an illustrative hybrid process for identifying similar songs in accordance with some embodiments of the disclosed subject matter;

FIG. 10 shows an illustrative process for creating an onset strength envelope in accordance with some embodiments of the disclosed subject matter;

FIG. 11 is an example of a diagram showing a linear-frequency spectrogram, a Mel-frequency spectrogram, and an onset strength envelope for a portion of a song in accordance with some embodiments of the disclosed subject matter;

FIG. 12 shows an illustrative process for identifying a primary tempo period estimate in accordance with some embodiments of the disclosed subject matter;

FIG. 13 is an example of a diagram showing an onset strength envelope, a raw autocorrelation, and a windowed autocorrelation for a portion of a song in accordance with some embodiments of the disclosed subject matter;

FIG. 14 shows a further illustrative process for identifying a primary tempo period estimate in accordance with some embodiments of the disclosed subject matter;

FIG. 15 shows an illustrative process for identifying beats in accordance with some embodiments of the disclosed subject matter; and

FIG. 16 is an example of a diagram showing a Mel-frequency spectrogram, an onset strength envelope, and chroma bins for a portion, of a song in accordance with some embodiments of the disclosed subject matter.

### DETAILED DESCRIPTION

In accordance with various embodiments, mechanisms for identifying similar songs using two-dimensional Fourier transform magnitudes are provided. These mechanisms can be used in a variety of applications. For example, cover songs of a query song can be identified. A cover song can include a song performed by one artist that is a version of a song performed by another artist or the same artist at a different time. As another example, similar songs (e.g., two songs with similar sounds, whether unintentional (e.g., due to coincidence) or intentional (e.g., in the case of sampling, copying, or through the creation of a derivative work such as a song parody)) can be identified. As yet another example, different songs with common, distinctive features can be identified (e.g., songs from a similar performer, the same performer, songs with a similar style, etc) for recommending songs to a user by identifying features of a query song. As a still further example, a song being played can be identified (e.g., the mechanisms described herein can allow a user to identify the name of a song on the radio, or the name of a song being played live by the original performer or another performer, such as a cover band).

In some embodiments, these mechanisms can receive a song or a portion of a song. For example, songs can be received from a storage device, from a microphone, or from any other suitable device or interface. A song can be received in any suitable format. For example, in some embodiments, die song can be received as: analog audio data; a bit stream of digital audio data; a file formatted in an uncompressed file format such as Waveform Audio File Format (WAV), Audio interchange File Format (AIFF), or the like; a file formatted using a compression format featuring lossless compression such as MPEG-4 SLS format. Free Lossless Audio Codec (FLAC) format, or the like; a file formatted using a compression format featuring lossy compression such as MP3, Advanced Audio Coding (AAC), or the like; or any other suitable format.

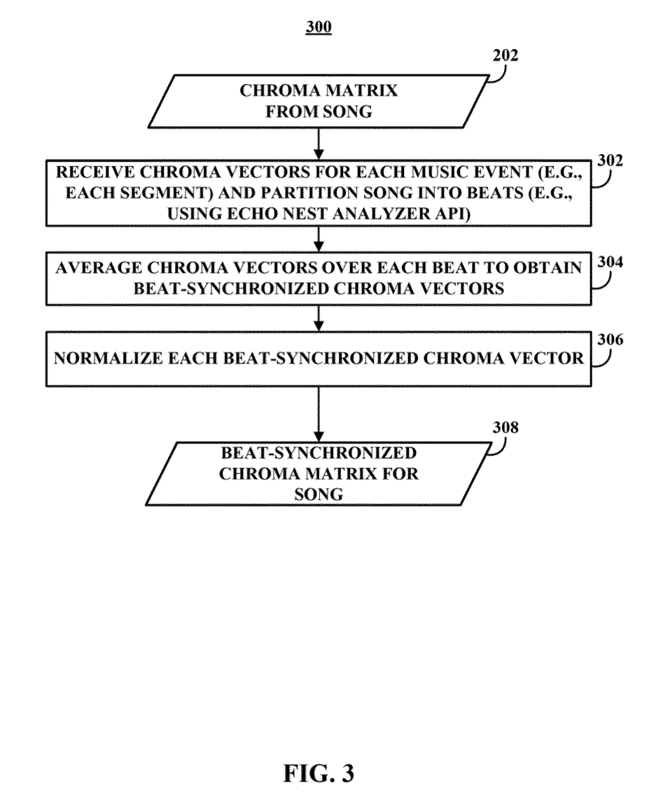

Beats in the song can then be identified. By identifying beats in the song, variations in tempo between two songs (e.g., between an original recording and a cover) can be normalized. Beat-level descriptors in the song can then be generated using any suitable techniques, as described below in connection with FIGS. 3 and 10-16, for example. It should be noted that references herein to a song are intended to encompass a full song as well as a portion(s) of a song.

In some embodiments, chroma vectors can be extracted from the song in accordance with musical segments of the song or based on time periods. In general, a chroma vector can represent audio information from a particular period of time in a portion of audio, wherein the chroma vector can be characterized as having twelve bins. Each of these twelve bins can correspond to one of twelve semitones (e.g., piano keys) within an octave formed by folding all octaves together (e.g., putting the intensity of semitone C across all octaves in the same semitone bin 1, putting the intensity of semitone C# across all octaves in the same semitone bin 2, putting the intensity of semitone D across all octaves in the same semitone bin 3, etc). In some embodiments, the semitone bins of a chroma vector can be numbered from one to twelve such that the lowest pitched semitone can be labeled as bin 1, and the highest pitched semitone can be labeled as bin 12. These chroma vectors can then be averaged over each, beat to create a beat-level feature array of beat-synchronized chroma vectors.

Chroma vectors can be extracted from a song, from a portion of a song, or from any portion of audio using any suitable techniques. For example, in some embodiments, an application such as The Echo Nest analyzer API (available at the web page of The Echo Nest, e.g., the echonest.com) can be used to extract chroma vectors (among other information) from, a portion of audio, such as a song or a portion of a song. Additionally or alternatively, in some embodiments, the processes described hereinbelow in connection with FIGS. 10-16 can be used to extract beat synchronized chroma vectors from a portion of audio.

In some embodiments, the beat-synchronized chroma vectors can be normalized. As described below in connection with FIG. 3 and FIGS. 10-16, any suitable technique can be used to normalize chroma vectors.

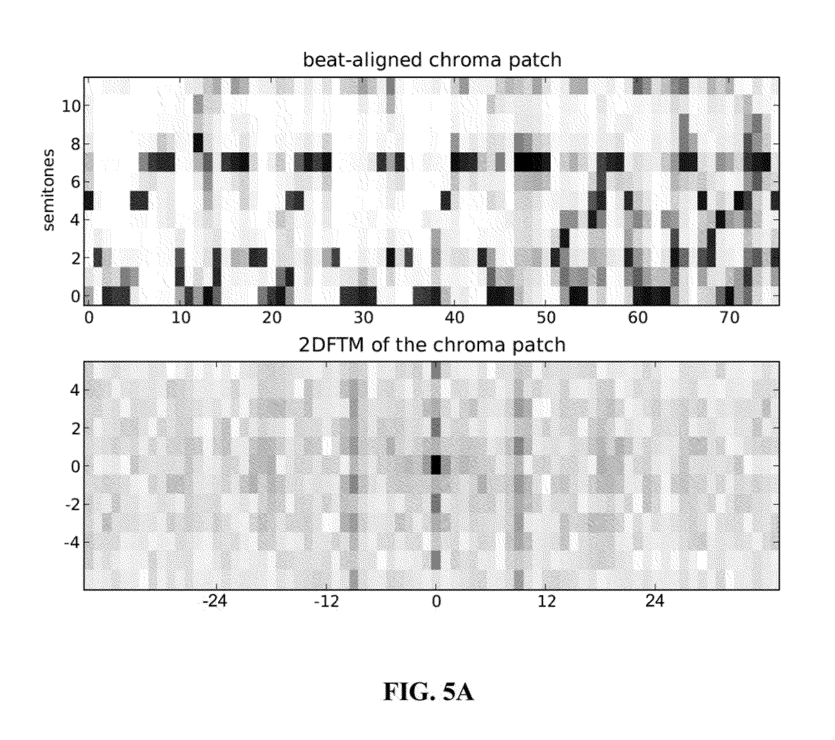

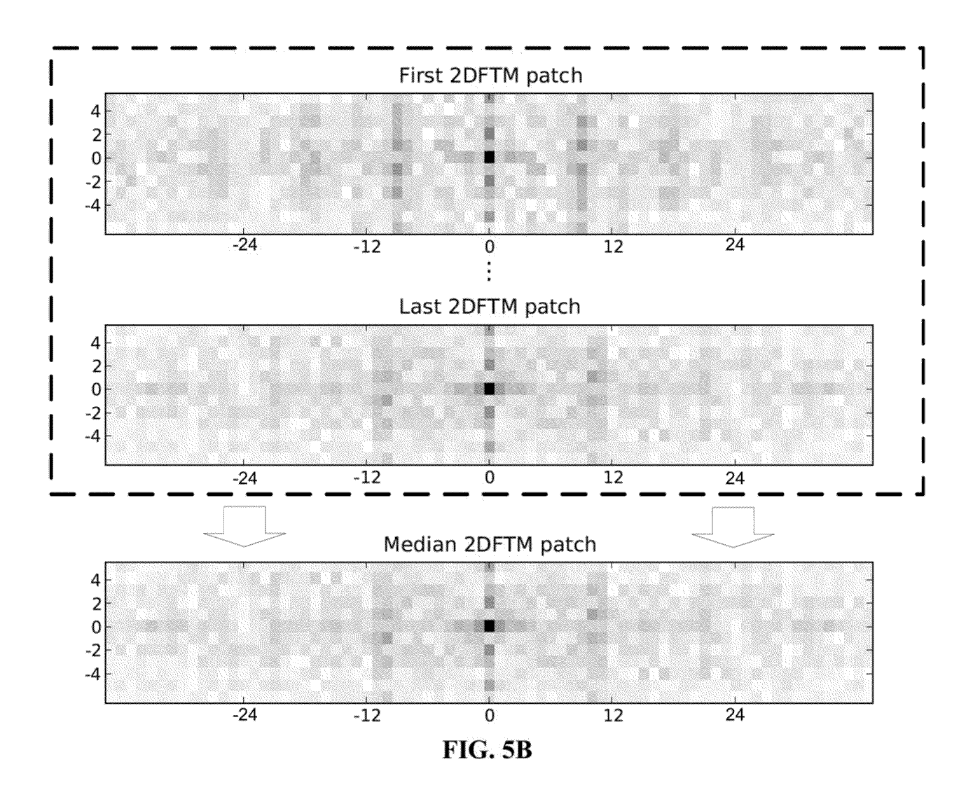

In some embodiments, various chroma vectors from a portion of audio can be concatenated to form an array of chroma of chroma vectors that can be referred to as a chroma matrix, which can represent a longer portion of the song. An example of a chroma matrix is described below in connection with FIG. 5A where it is referred to as a beat-aligned chroma patch. In some embodiments, a chroma matrix can include any suitable number of chroma vectors suitable for representing a portion of a song. For example, if beat-synchronized chroma vectors are used to represent audio information from a song, a chroma matrix can include a chroma vector for each beat in the song.

In some embodiments, a portion of a chroma matrix (which can include the entire chroma matrix) can be referred to as a chroma vector patch (or sometimes a chroma patch) and can be an array of chroma vectors that represents a particular period of time in die chroma matrix.

In some embodiments, a two-dimensional Fourier transform can be found for each of various chroma patches that are each an array of beat-synchronized chroma vectors. The two-dimensional Fourier transform can represent the distribution of values in the various bins in an array of beat-synchronized chroma vectors (e.g., in a chroma patch). For example, taking the two-dimensional Fourier transform of a patch of beat-synchronized chroma vectors can extract different levels of detail from, patterns formed in the patch, in some embodiments, the values obtained from taking the two-dimensional Fourier transform of a chroma patch can be organized as a matrix of bins in a similar manner as the chroma patch, and can be referred to as a two-dimensional Fourier transform patch.

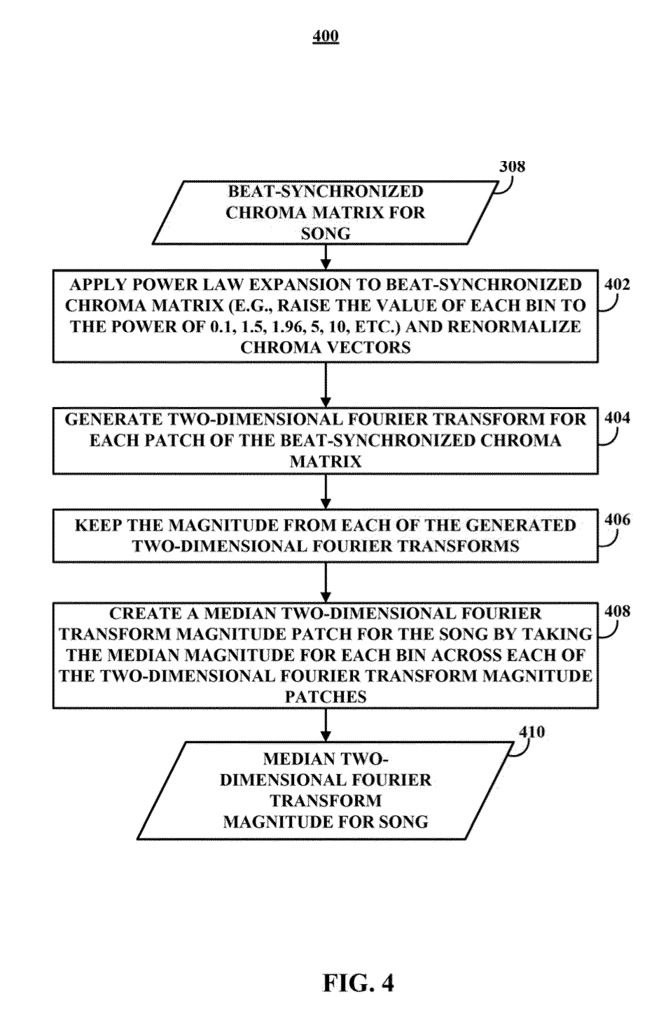

In some embodiments, two-dimensional Fourier transform magnitudes can be found for each of the various two-dimensional Fourier transform patches. For example, removing the phase component (e.g., keeping only the magnitude) of the two-dimensional Fourier transform patch can provide in variance to transposition in the pitch axes (e.g., in variance to transposition of the key in which a song is performed) and invariance to skew on the beat axis (e.g., misalignment in time of when notes are played), as described below in connection with FIG. 4.

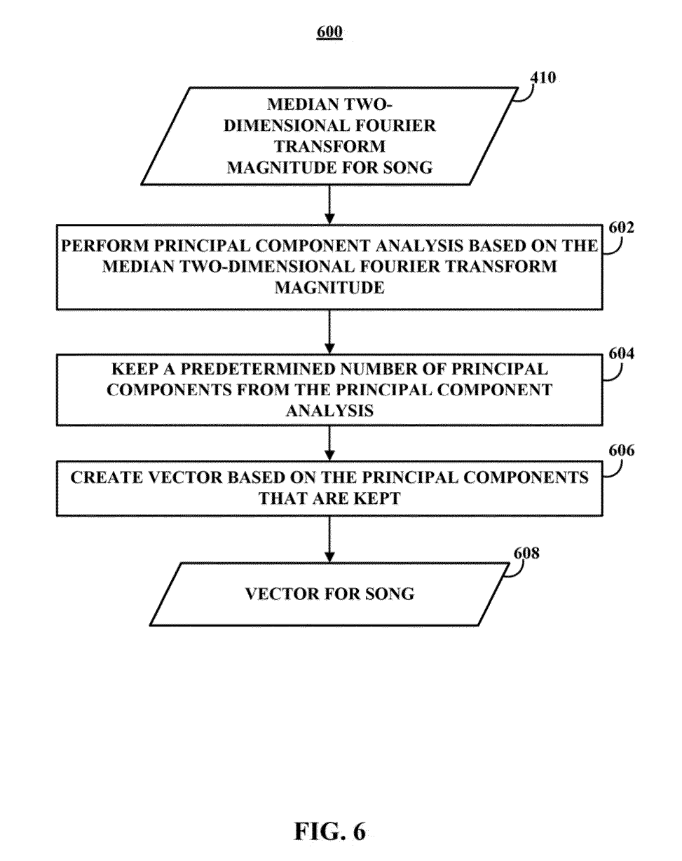

In some embodiments, a principal component analysis can be performed, based on a two-dimensional Fourier transform magnitude patch to create a vector that represents the patch in a multi-dimensional space, in general, principal component analysts (PCA) is a mathematical process by which a data, set can be transformed to extract variables called principal components. These principal components can be calculated in such a way that the first principal component represents the most information about the data in the data set, that is, so that the first principal component accounts for as much of the variability in the data as possible, in general, the number of principal components is less than or equal to the number of variables or values in the original data set. As described below in connection with FIG. 6, a vector that represents a patch can be created from a predetermined number of principal components found by performing principal component analysis of a two-dimensional Fourier transform magnitude patch.

In some embodiments, vectors created in this way can be compared, and a distance between two vectors in the multi-dimensional space can represent a degree of difference (or similarity) between the patches which the vectors represent. For example, if vectors created from two songs are relatively close in the multi-dimensional space, they may be similar songs, or one of the songs may be a cover of the other song.

Turning to FIG. 1, an example 100 of a process for comparing a query song 102 (or portion of a query song) to one or more reference songs in accordance with some embodiments is shown. As shown, process 100 can include extracting a chroma matrix from a song at 104, generating a beat-synchronized chroma matrix from the extracted chroma matrix at 106, generating one or more two-dimensional Fourier transform magnitude patches (sometimes referred to herein as a “2DFTM”) from the beat-synchronized chroma matrix at 108, creating and storing a vector corresponding to the song (or portion of a song) in a song database 112 at 110, comparing vectors created at 110 to vectors stored in song database 112 at 114, and outputting results of the comparison 116 that indicate whether one or more reference songs stored in database 112 are similar to a query song input at 102 based on a distance between the vectors created from the reference song(s) and query song respectively.

As shown, at 104, a chroma matrix can be extracted from a song 102. The chroma matrix can be extracted using any suitable technique, such as, using The Echo Nest analyzer API, using the processes described in connection with FIGS. 10-16, or using any other suitable technique.

At 106, a beat-synchronized chroma matrix can be generated from the chroma matrix extracted at 104. In some embodiments, generating a beat-synchronized chroma matrix can include averaging chroma vectors over each beat to create beat-synchronized chroma vectors. Additionally or alternatively, generating a beat-synchronized chroma vectors can include normalizing beat-synchronized chroma vectors using any suitable technique. As one example, techniques described in connection with FIG. 3 can be used to normalize the beat-synchronized chroma vectors.

At 108, one or more two-dimensional Fourier transform magnitude patches can be generated based on the beat-synchronized chroma matrix generated at 106. In some embodiments, two-dimensional Fourier transform magnitudes can be found for various patches within the beat-synchronized chroma matrix. For example, a two-dimensional Fourier transform, can be taken for each patch of a certain length in a song (e.g., eight beat patches, twenty beat patches, 75 beat patches, one hundred beat patches, etc.) and the magnitudes can be kept (e.g., the phase component can be discarded).

These patches can be combined to generate a single two-dimensional Fourier transform magnitude patch to represent, an entire song (or portion of a song). Any suitable technique can be used to generate a two-dimensional Fourier transform magnitude patch that can be used to represent an entire song (or portion of a song). For example, in some embodiments, a mean can be taken of the two-dimensional Fourier transform magnitude patches that are generated from each patch of die beat-synchronized chroma matrix. As another example, a median of the two-dimensional Fourier transform magnitude patches can be found at each location within the two-dimensional Fourier transform magnitude patch. As yet another example, a mode of the two-dimensional Fourier transform magnitude patches can be found at each location within the two-dimensional Fourier transform magnitude patch. As still another example, a variance of the two-dimensional Fourier transform magnitude patches can be found at each location within the two-dimensional Fourier transform magnitude patch.

At 110, one or more vectors can be created to correspond to song 102 based on the two-dimensional Fourier transform magnitude patch(s) generated at 108. In some embodiments, a vector can be created by performing a principal component analysis (PCA) of a two-dimensional Fourier transform magnitude patch and by keeping a predetermined number of principal components (PCs) that result from the PCA (up to and including all of the PCs).

In some embodiments, the PCs that have been kept can be used to create a vector (where the number of dimensions of the vector can equal the number of PCs that have been kept) that, represents a two-dimensional Fourier transform magnitude patch. Any suitable number of vectors can be created for each song. For example, in some embodiments, a vector can be created for each two-dimensional Fourier transform magnitude patch that is generated from the beat-synchronized chroma matrix. Additionally or alternatively, a single vector can be created from a two-dimensional Fourier transform magnitude patch that is representative of an entire song (or portion of a song) by, for instance, being made up of the median magnitude at each position of the 2DFTM patch.

In some embodiments, the vector (or vectors) can be stored in song database 112 in association with information identifying the song (e.g., a song title, an identification of an artist that performed the song, a username associated with the song, etc.). Songs for which vectors are stored in song database 112 can be referred to as reference songs.

At 114, a vector (or vectors) created from song 102 (or a portion of a song 102) can be compared to vectors of other songs (or portions of songs), such as vectors previously stored in database 112. The results of the comparison can be presented at 116 in any suitable fashion, such as by presentation on a display of a computing device.

In some embodiments, the mechanisms described herein can include a process 120, shown in FIG. 1 that takes a chroma matrix for a song as an input and adds a vector(s) created from the chroma matrix to database 112 and/or compares a vector(s) created from the chroma matrix to one or more vectors stored in database 112.

FIG. 2A shows an example 200 of a process for creating a database of reference song vectors using process 120 of FIG. 1 in accordance with some embodiments.

At 204, a beat-synchronized chroma matrix can be generated for a chroma matrix from a reference song 202. In some embodiments, the beat-synchronized chroma matrix can be generated in accordance with the techniques described in connection with 106.

In some embodiments, chroma matrix 202 can be received, as a beat-synchronous chroma matrix, in such an embodiments, 204 can be omitted and process 200 can proceed to 206.

At 206, one or more two-dimensional Fourier transform magnitude patches can be generated based on a reference song beat-synchronized chroma matrix. In some embodiments, the two-dimensional Fourier transform magnitude patches can be generated based on the reference song beat-synchronized chroma matrix generated at 204.

In some embodiments, two-dimensional Fourier transform magnitude patches can be generated in accordance with the techniques described above in connection with 108 and/or described below in connection with FIG. 4. In some embodiments, the two-dimensional Fourier transform magnitude patches can be stored in a database, such as song database 112, in association with the song (or information about the song, such as song metadata) that the two-dimensional Fourier transform magnitude patches are derived from. Additionally or alternatively, the two-dimensional Fourier transform magnitude patches can be stored in memory for use in creating a vector(s) that represents the song.

At 208, a vector(s) can be created from the two-dimensional Fourier transform magnitude patches for a reference song, being analyzed. In some embodiments, a vector(s) can be created in accordance with the techniques described herein. More particularly, a vector(s) can be created from one or more two-dimensional Fourier transform magnitude patches in accordance with the techniques described in connection with 110 and/or FIG. 6.

At 210, the vector(s) created at 208 can be stored in a database (such as song database 112) as reference song vectors. As described below in connection with FIG. 6, storing the vector(s) in the database, in addition to or instead of the two-dimensional Fourier transform magnitude patch(es) can allow for a distance metric, such as a Euclidian distance, to be calculated between a reference song and a query song by comparing the reference song vectors to the query song vector.

In some embodiments, the vector(s) can be stored in a database (such as song database 112) in association with identification information of the audio from a song that the vector(s) correspond(s) to. For example, the vector can be stored in a database along with a corresponding identifier. In such an example, any suitable identifier or identifiers can be used. For instance, in the case of a known song, the artist, title, song writer, etc. can be stored in association with the vector, in another example, a URL of a video of an unknown song can be stored in association with the vector. In yet another example, identifying information about an unknown song, such as a source and/or a location of the unknown song, can be stored in association with the vector corresponding to the unknown, song.

In some embodiments, vectors can be created from a collection of known songs. For example, a content owner (e.g., a record company, a performing rights organization, etc.) can create vectors from songs in the content owner's collection of songs and store the vectors in a database. En such an example, information (e.g., title, artist, song writer, etc.) identifying the songs can be associated with the vectors.

In some embodiments, as described above in connection with 108 and below in connection with FIG. 6, a single two-dimensional Fourier transform magnitude patch can be created mat represents an entire song. For example, as described herein, a median magnitude can be taken for each position of a patch, and a median two-dimensional Fourier transform patch can be created using these median magnitudes. Such a median two-dimensional Fourier transform patch can be used in creating a vector for comparing songs. This can allow for a cover song that has been rearranged in time as compared to a different version of the song to be identified. For example, the median magnitude of the two-dimensional Fourier transform magnitude patches are less likely to be affected by rearrangement than characteristics used in other techniques, such as fingerprinting techniques.

FIG. 2B shows an example 250 of a process for creating a vector for a query song and comparing the query song vector to a database of reference song vectors using process 120 of FIG. 1, in accordance with some embodiments.

Process 250 can begin by creating a query song vector from, a chroma matrix 252 for a query song at 254-258, which can be performed as described, above in connection with 204-208, respectively, of process 200 for creating a vector of a reference song.

At 260, the vector created at 258 can be compared to the reference song vector(s) that were stored in the database at 210 using process 200. In some embodiments, the comparison can include finding a distance metric between the query song vector and each reference song vector in the multi-dimensional space defined by the vectors. For example, a Euclidean distance can be found between a query song vector and a reference song vector.

At 262, reference songs that are considered similar to the query song can be determined based on the distance metric between the reference song vector and the query song vector. In some embodiments, each reference song for which the reference song vector is within a predetermined distance of the query song vector can be considered a similar reference song. Alternatively, the distance between the query song vector and each of the reference song vectors can be found, and a predetermined number of reference songs with the smallest distance (e.g., one song, fifty songs, all reference songs, etc.) can be kept as similar songs.

When reference song vectors corresponding to some portion of reference songs stored in the database (including all of the reference songs) have been compared at 262 to the query song vectors), the results of the comparison can be output at 116.

In some embodiments, the processes of FIGS. 2A and 2B can be used, together to identify similar songs using process 250 by comparing query song vectors to vectors stored in a database in accordance with process 200. For example, a content distributor (e.g., a radio station, a music retailer, etc.) can create vectors from songs made available by the content distributor as reference song vectors. In such an example, information (e.g., title, artist, song writer, etc.) identifying the songs can be associated with the reference song vectors. Further, a query song (which may be a song made available by the content distributor) can be input, and songs similar to the query song that are available from the content distributor can be recommended to a user. For instance, a reference song that has a vector with a smallest distance to the query song can be recommended to the user. In such an example, a song that is identical to the query song can be excluded from being recommended by, for example, using fingerprinting techniques to determine if the reference songs include a song that is identical to the query song.

In some embodiments, multiple vectors can be created for the query song and/or for each reference song based on different tempos. For example, a first vector for a song can be created based on an beat-synchronized chroma matrix created using an initial tempo estimate. After an initial tempo is estimated, one or more additional beat-synchronized chroma matrix can be created based on multiples (e.g., two times the initial estimate, three times the initial estimate, etc) and/or fractions (e.g., one half the initial estimate, one quarter of the initial estimate, etc.) of the initial tempo estimate.

In some embodiments, any different versions of the reference song vector for each reference song can be stored in database 112 and a query song can be compared to each of version of the vector for each reference song. It should be noted that different version may be created for only a subset of reference songs, for example, if the tempo is difficult to determine or is ambiguous. Additionally or alternatively, different versions of the query song vector can be compared to reference song vectors (of which there may or may not be different versions) and the closest reference song vector(s) across all versions or the query song vector can be identified as a cover of the query song.

In some embodiments, vectors can be extracted from a collection of unknown songs. For example, a user can create reference song vectors from soundtracks to videos uploaded (by the user and/or by other users) to a video sharing Web site (e.g., YOUTUBE). In such an example, information identifies the source of the soundtrack (e.g., a URL, a username, a reference number, etc.) ears be associated with the reference song vectors. The information identifying the source of the soundtracks and associated reference song vectors can be used to create a collection of unknown songs. A user can then input a query song and search for different versions of the query song by finding a distance between a query song vector and the reference song vectors created from the soundtracks associated with the collection of unknown songs.

FIG. 3 shows an example 300 of a process for obtaining a normalized beat-synchronous chroma matrix from an input chroma matrix 202, in accordance with some embodiments. In some embodiments, chroma matrix 202 can be obtained using any suitable technique, such as, by using The Echo Nest analyzer API, using the processes described in connection with FIGS. 10-16, or any other suitable technique. In accordance with some embodiments, process 300 can be used to generate a beat-synchronized chroma matrix at 106, 204 and/or 254.

At 302, chroma vectors corresponding to each music event can be generated or received and the song can be partitioned into beats. An example of a musical event can include a time at which there is a change in pitch in the song. In some embodiments, whenever there is a musical event, a chroma vector can be calculated. Musical events can happen within a beat or can span beats. In some embodiments, the chroma matrix 202 can already be partitioned into beats, for example, by The Echo Nest analyzer API. Other techniques for partitioning a chroma matrix into beats are described below in reference to FIGS. 10-16.

At 304, chroma vectors received at 302 can be averaged over each beat to obtain beat-synchronized chroma vectors. Any suitable technique can be used to average chroma vectors over a beat, including techniques for averaging chroma vectors described below in connection with FIGS. 10-16.

At 306, the beat-synchronized chroma vectors can be normalized and a beat-synchronized chroma matrix 308 can be output for use in mechanisms described herein. In some embodiments, the value in each chroma bin of a beat-synchronized chroma vector can be divided by the value in the chroma bin having a maximum value. For example, if chroma bin 3 of a particular chroma vector has a maximum value of chroma bins 1 through 12, then the value of each of chroma bins 1 through 12 can be divided by the value of chroma bin 3. This can result in the maximum value in a chroma bin being equal to one for the normalized beat-synchronous chroma vectors. It should be noted that other operations can be performed to the chroma matrix prior to outputting beat-synchronized chroma matrix 308. For example, beat-synchronized chroma vectors can be averaged over pairs of successive beats, which can reduce the amount of information contained in the beat-synchronized chroma matrix for a song.

Turning to FIG. 4, an example 400 of a process for generating landmarks for a song from a beat-synchronized chroma matrix 308 in accordance with some embodiments is illustrated. At 402, the value in each bin of the beat-synchronized chroma matrix 308 can be raised to an exponent. Raising each chroma bin value to an exponent can increase the contrast between chroma bins having a relatively high value and chroma bins having a relatively low value, in some embodiments. In some embodiments, the value in each chroma bin can be raised by any suitable power, such as, 0.1, 1.5, 1.96, 5, 10 etc., and then each chroma vector can be renormalized based on the raised values, in accordance with some embodiments, process 400 can be used to set and store landmarks at 108, 206 and/or 256.

At 404, a two-dimensional Fourier transform can be generated for each patch of the beat-synchronized chroma matrix. For example, a two-dimensional Fourier transform can be generated for each patch of a particular length (e.g., 8 beats, 20 beats, 50 beats, 75 beats, etc.) of consecutive chroma vectors in the beat-synchronized chroma matrix. As an illustrative example, if 75 beat patches are used for generating two-dimensional Fourier transforms, for a song that has 77 beats (e.g., 77 beat-synchronized chroma vectors), three two-dimensional Fourier transforms can be generated, one for each patch of 75 beats in the song.

Any suitable techniques can be used to generate the two-dimensional Fourier transforms. For example, a fast Fourier transform (FFT) of a patch of the beat synchronized chroma matrix can be found as the two-dimensional Fourier transform of the patch. In such an example, any suitable techniques for performing a FFT can be used. In a more particular example, the following equation can be used determine the two-dimensional Fourier transform, F(u,v), of a beat-synchronized chroma matrix patch:

$$F ( u , v ) = \frac{1}{\sqrt{MN}} {\sum }_{x = 0}^{M - 1} {\sum }_{y = 0}^{N - 1} f ( x , y ) {e}^{- 2 i π * ( \frac{ux}{M} + \frac{vy}{N} )} , \qquad ( 1 )$$

with f(x, y) being the value of the beat-synchronized chroma patch at coordinates (x,y), where x represents the beat axis and y represents the semitone axis. In such an example, the total number of values of the two-dimensional Fourier transform can be equal to the number of bins in the beat-synchronized chroma matrix. More particularly, the size of the two-dimensional. Fourier transform can be equal to the size of the beat-synchronized chroma matrix, such that x*y=u*v, for equation (1).

At 406, the magnitude at each position of the two-dimensional Fourier transform found using equation (1) can be found using equation (2), as follows:

mag(u,v)=\sqrt{{F(u,v)}+ℑ{F(u,v)}}, (2)

with returning the real part of a complex number, and returning the imaginary part of the complex number. FIG. 5A shows an example of a beat-synchronous chroma patch representing 75 beat-synchronized chroma vectors after applying a power expansion, as in 402, and the magnitudes of a two-dimensional Fourier transform patch (sometimes referred to herein as a 2DFTM) of the beat-synchronized chroma patch. It should be noted that for visualization purposes, the bins of the 2DFTM are shifted so that the center of the axis system (e.g., the origin) is in the middle of the image and the magnitudes have been raised to the power of one half (0.5). In the representation shown in the example of FIG. 5A, it can be appreciated that the 2DFTM is symmetrical about the origin.

As described above in connection with 404, a 2DFTM can be generated for each patch of a particular length in the beat-synchronized chroma matrix. This can result in various 2DFTMs being generated that each represent part of a song.

At 408, a median two-dimensional Fourier transform magnitude 410 (e.g., a median 2DFTM) can be created from the 2DFTMs generated at 402-406. For example, a median can be found for each bin location within the 2DFTM patches, and these medians can be combined to form a median 2DFTM patch that can represent information about the entire song. Using the labeling conventions of equations (1) and (2), for each location (u,v) in each 2DFTM, a median can be found across all 2DFTM patches generated, at 402-406. In a particular example, if there are three 75 beat 2DFTM patches, a median from among the three can be found at each location within each of the patches. It should be noted that the location discussed here refers to a local location within the patch, not a location within the song as a whole.

FIG. 5B shows an example of a first 2DFTM patch and a last 2DFTM patch generated from a song, wherein each of these is generated from 75 beat long beat-synchronized chroma patches. These first and last patches, along with other patches between the first and last patch (e.g., all the patches from a song), can be used to create a median 2DFTM generated from various 2DFTMs, as described in above in connection with FIG. 4. It should be noted that, although taking a median of the 2DFTM patches generated from the song is described as an example, any suitable technique for extracting information from the various 2DFTMs that are generated from a song can be used. For example, a median can be taken for each bin, a mode can be found for each bin, a variance can be found for each bin, etc. It should also be noted that, the 2DFTMs generated at 402-406 can be kept and compared to 2DFTMs generated for other songs (e.g., by comparing vectors created from the various 2DFTM patches), rather than extracting information from the various 2DFTMs to create a single patch to represent an entire song.

FIG. 6 shows an example 600 of a process for creating a vector based on an input two-dimensional Fourier transform magnitude patch. At 602, principal component analysis (PCA) can be performed on median 2DFTM 410 in order to extract a set of principal components from the median 2DFTM. PGA can transform data (e.g., 2DFTM data) from a first coordinate system to a new coordinate system. The transformation can be performed as an orthogonal linear transformation that projects the data from the first coordinate system into the new coordinate system, such that the greatest variance by any projection of the data comes to lie on a first coordinate (e.g., a first principal component), the second greatest variance on the second coordinate (e.g., a second principal component), and so on. Performing PCA on median 2DFTM 410 can reduce the dimensionality and allow for comparisons between median 2DFTMs from different songs based on a relatively straightforward distance metric calculation, such as a Euclidean distance. Any suitable technique can be used for performing PCA.

In some embodiments, a number of principal components generated when performing PCA can be equal to the number of values of the original data. For example, performing PCA on a 2DFTM patch having 900 values (e.g., based on beat-synchronized chroma patches of 75 beats in length, with 12 semitones representing each beat) can result in a total of 900 principal components (PCs). In some embodiments, a number of principal components generated from performing PCA on median 2DFTM 410 are redundant due to symmetry in the 2DFTM (e.g., 450 of 900 principal components in the previous example may be redundant due to symmetry) and, therefore, can be ignored or discarded.

In some embodiments, the PCA can be performed without normalizing the data of the median 2DFTM being analyzed. Instead, for example, the data of the 2DPTM can be centered to zero and rotated.

At 604, a predetermined number of principal components can be kept from the principal components that resulted from performing PCA at 602. Any suitable number of principal components can be kept. For example, in some embodiments, the first fifty principal components can be kept. As another example, the first principal component can be kept. As yet another example, two hundred principal components can be kept. As still another example, all principal components generated from performing PCA can be kept.

At 606, the principal components) kept at 604 can be used to create a vector 608 with the kept principal components forming the values of the vector, in some embodiments, the number of dimensions of the vector can be equal to the number of principal components kept at 604. It should be noted that it is possible that the value of some of the principal components can be equal to zero. For example, a song that has very consistent patterns and/or little variation in its patterns can have a simpler Fourier transform than a song with less consistent patterns and more variation. Vector 608 can represent information on an entire song or a portion of a song which can be used to compare songs to one another using a distance metric, such as a comparison of a Euclidean distance between vectors for two different songs.

FIG. 7A shows an example of a generalized schematic diagram of a system 700 on which the mechanisms for identifying cover songs using two-dimensional Fourier transform magnitudes described herein can be implemented in accordance with some embodiments. For example, the mechanisms described herein can be implemented as a collection of one or more applications that can be executed on system 700.

As illustrated, system 700 can include one or more computing devices 710. Computing devices 710 can be local to each other or remote from each other. Computing devices 710 can be connected by one or more communications links 708 to a communications network 706 that can be linked via a communications link 706 to a server 702.

System 700 can include one or more servers 702. Server 702 can be any suitable server for providing access to or a copy of the one or more applications. For example, server 702 can include or be a hardware processor, a computer, a data processing device, or any suitable combination of such devices. For example, the one or more applications can be distributed into multiple backend components and multiple frontend components or interfaces. In a more particular example, backend components, such as data collection and data distribution, can be performed on one or more servers 702. In another more particular example, frontend components, such as a user interface, audio capture, etc., can be performed on one or more computing devices 710. Computing devices 710 and server 702 can be located at any suitable location.

In one particular embodiment, the one or more applications can include client-side software, server-side software, hardware, firmware, or any suitable combination thereof. For example, the application(s) can encompass a computer program written in a programming language recognizable by computing device 710 and/or server 702 that is executing the application(s) (e.g., a program written in a programming language, such as, Java, C, Objective-C, C++, C#, Javascript, Visual Basic, HTML, XML, ColdFusion, any other suitable approaches, or any suitable combination thereof).

More particularly, for example, each of the computing devices 710 and server 702 can be any of a general purpose device such as a computer or a special purpose device such as a client, a server, etc. Any of these general or special purpose devices can include any suitable components such as a hardware processor (which can be a microprocessor, digital signal processor, a controller, etc.), memory, communication interfaces, display controllers, input devices, etc. For example, computing device 710 can be implemented as a smartphone, a tablet computer, a personal data assistant (PDA), a personal computer, a laptop computer, a multimedia terminal, a game console, a digital media receiver, etc.

Communications network 706 can be any suitable computer network or combination of networks, including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any other suitable network. Communications links 704 and 708 can be any communications links suitable for communicating data between computing devices 710 and server 702, such as network links, dial-up links, wireless links, hard-wired links, any other suitable communications links, or any suitable combination of such links.

System 700 can also include a content owner server 732. Content owner server 732 can be operated by, for example, a record company, a copyright licensing organization, etc. In some embodiments, content owner server 732 can use songs owned by the content owner—or a party associated with the content owner, such as an agent, a copyright licensing organization, etc.—as query songs. Using the mechanisms described herein the content owner can automatically search for cover versions of the songs that are owned by the content owner. For example, content owner server 732 can search a database of songs or a content server 742.

In some embodiments, content server 742 can be a server, or multiple servers, that are part of a service (e.g., YOUTUBE, VIMEO, etc.) that allows users to upload user-generated content (including content copied from another source by a user, not only content created by a user). Using the mechanisms described herein can allow content owner server 732 to search for alternate versions of a song owned by the content owner (or a party that the content owner represents) in a database or content server 742 that contains unknown songs. Content owner server 732 and content server 742 can include any suitable hardware. For example, content owner server 732 and/or content server 742 can include hardware similar to that in server 702.

In some embodiments, content server 742 can maintain a database of beat-synchronized chroma matrices and/or vectors of songs uploaded to content server 742. Content server 742 can then allow users to input a query song and the content server can identify different versions of the song and/or similar songs to the user. This can be provided as part of a service to all users and/or as a service to content owners and/or copyright licensing organizations, such as BMI or ASCAP.

FIG. 7B illustrates an example of a portion of hardware 700 in which server 702 and one of computing devices 710 are depicted in more detail. As shown in FIG. 7B, computing device 710 can include a hardware processor 712, a display 714, an input device 716, and memory 718, which can be interconnected. In some embodiments, memory 718 can include a storage device (e.g., RAM, an EEPROM, ROM, a hard drive, solid state storage, etc.) for storing a computer program for controlling processor 712.

Hardware processor 712 can use the computer program to present on display 714 an interface that allows a user to interact with the application(s) and to send and receive data through communication link 708. It should also be noted that data received through communications link 708 or any other communications links can be received from any suitable source. In some embodiments, hardware processor 712 can send and receive data through communication links 708 or any other communication links using, for example, a transmitter, receiver, transmitter/receiver, transceiver, network interface card, or any other suitable communication device. Input device 716 can be a computer keyboard, a mouse, a touchpad, a voice recognition circuits), an optical gesture recognition circuit(s), a touchscreen, or any other suitable input.

Server 702 can include hardware processor 722, display 724, input device 726, and memory 728, which can be interconnected. In some embodiments, memory 728 can include a storage device (e.g., RAM, an EEPROM, ROM, a hard drive, solid state storage, etc.) for storing data received through communications link 704 or through other links, and/or a server program for controlling processor 722. Processor 722 can receive commands and/or values transmitted by one or more users through communications link 704 or through other links.

In one particular embodiment, the one or more applications can include client-side software, server-side software, hardware, firmware, or any suitable combination thereof. For example, the application(s) can encompass a computer program written in a programming language recognizable by the computing device executing the application(s) (e.g., a program written in a programming language, such as, Java, C, Objective-C, C++, C#, Javascript, Visual Basic, or any other suitable approaches).

In some embodiments, the one or more applications with a user interface and mechanisms for identifying cover songs, and other functions, can be delivered to computing device 710 and installed, as illustrated in example 800 shown in FIG. 8A. At 802, vectors for one or more reference songs can be stored in a database by server 702. In one example, the creation of the reference song vectors can be done by server 702. In another example, the creation of the reference song vectors can be performed using any suitable device and can be transmitted to server 702 in any suitable manner. At 804, the reference song vectors stored at 802 can be transmitted to computing device 710 as part of the application for utilizing the mechanisms described herein. It should be noted that transmitting the application(s) to computing device 710 can be done from any suitable device and is not limited to transmission from server 702. It should also be noted that transmitting the application(s) to computing device 710 can involve intermediate steps, such as, downloading the application(s) to a personal computer or other device, and/or recording the application(s) in memory or storage, such as a hard drive, a flash memory, a SIM card, a memory card, or any other suitable device for temporarily or permanently storing an application(s).

Computing device 710 can receive the application(s) and reference song vectors from server 702 at 806. After the application(s) is received at computing device 710, the application can be installed and can be used to receive audio data for a query song 102 at 808 as described herein in connection with FIG. 1. The application(s) executing on computing device 730 can create a query song vector from the query song 102 at 810 in accordance with process 250 described above in connection with FIG. 2B, and can compare the query song vector to one or more reference song vectors in accordance with process 250, described above in connection with FIG. 2B. For example, a Euclidean distance metric can be found between the query song vector and the one or more reference sons vectors.

At 812, the one or more application(s) can determine if the distance between the query song vector and any of the reference song vectors is below a threshold. In some embodiments, the threshold can be set based on a set of training data to provide a tradeoff between the number of false positives (e.g., a match is reported even when the reference songs are known to not contain any cover songs) and false negatives (e.g., a match is not reported even when the reference songs are known to contain one or more cover songs). Alternatively, the threshold can be set dynamically based on the distance between the query song and each of the reference songs. For example, a fixed proportion of the distance between the query song and the median reference song (e.g., the reference song for which half of the reference songs are closer to the query song and half of the reference songs are farther from the query song than the median reference song), or between the query song and the tenth percentile reference song (e.g., ninety percent of reference songs are closer than the tenth percentile reference song). In a more particular example, if the distance between the query song vector and a particular reference song vector is less than one percent, of the distance to the tenth percentile reference song (e.g. 0.01*10^{th} percentile distance), the particular reference song vector can be included as a similar song.

If the application(s) determine(s) that at least one reference song exists for which the distance between the query song vector and the reference song vector is less than the threshold (“YES” at 812), the application(s) can proceed to 814 and output a list of reference songs having the shortest distance to the query song (e.g., the closest reference songs). Otherwise, if the application(s) running on computing device 710 determine(s) that there are no reference songs with a distance less than the threshold (“NO” at 812), the application(s) can proceed to 816 and output an empty list or other suitable indication that no similar reference songs were found.

If some embodiments, the application's) with a user interface and mechanisms for receiving query song data (e.g., audio data for a song or a portion of a song) and transmitting query song data, and other user interface functions can be transmitted to computing device 710 (e.g., a mobile computing device), but the reference song vectors can be kept on server 702, as illustrated in example 850 shown in FIG. 8B. Similarly to the example in FIG. 8A, at 852, reference song vectors can be stored in a database in accordance with the mechanisms described herein. Server 702 can transmit the application(s) (or at least a portion of the application's)) to computing device 710 at 854. Computing device 710 can receive the application(s) at 856

Computing device 710 can start receiving and transmitting query song data (e.g., audio data for a query song) to server 702 at 858. It should be noted that, in some embodiments, query song data can include audio data for a query song, chroma vectors of a query song, a chroma matrix for the query song, a beat-synchronized chroma matrix for the query song, two-dimensional Fourier transform patches for the query song, a median 2DFTM for the query song, a query song vector, and/or any other suitable data about the query song. In some embodiments, query song data can be received and/or generated by computing device 710 and can be transmitted to server 702 at 858.

At 860, server 702 can receive query song data from computing device 710, create a query song vector in accordance with 258 of process 250 of FIG. 2B (if computing device 710 has not already done so), and compare the query song vector to one or more reference song vectors in accordance with 260 of process 250 of FIG. 2B. At 862, server 702 can determine if a distance between the query song vector and any particular reference song vectors is below a threshold, similarly to 812 of FIG. 8A described above, to determine if a reference song exists that is similar to the query song at 862.

If the application(s) running on server 702 and/or computing device 710 determines that at least one reference song exists for which the distance between the query song vector and the reference song vector is less than the threshold (“YES” at 862), the application(s) can proceed to 864 and generate a list of reference songs having the shortest distance to the query song (e.g., the closest reference songs) to be transmitted to computing device 710. Otherwise, if the application(s) running on server 702 determines that there are no reference songs with a distance less than the threshold (“NO” at 862), the application(s) can return to 860 to receive more query song data. It should be noted that, although not shown in FIG. 5B, if no reference song is within a threshold distance of the query song at 862 an empty list or the like can be generated to be transmitted to computing device 710 to indicate that no similar reference songs were found.

As mentioned above, at 864, server 702 can generate a list of reference songs having the shortest distance to the query song (e.g., the closest reference songs) based on the distance between the query song vector and the reference song vector(s). Server 702 can then transmit the list of similar reference songs to computing device 710. In some embodiments, server 702 can transmit audio and/or video of the similar songs (or a link to audio and/or video of the similar songs, which can include, for example, an image associated with the similar song) at 864 in addition to a listing of the similar songs.

After receiving and transmitting query song data at 858, computing device 710 can proceed to 866 where it can be put into a state to receive a list of similar songs from server 702, and can move to 868 to check if a list of songs has been received from sewer 702. If a list, of similar songs has been received (“YES” at 868), computing device 710 can proceed to 870 where it can provide the list of similar songs to a user of the computing device in accordance with process 100 of FIG. 1 and/or process 250 of FIG. 2B. If a list of similar songs has not been received or an empty list (or the like) has been received (“NO” at 858), computing device 710 can output a message to a user to inform the user that no similar songs were found and process 850 can return to 858 where it can receive and transmit more query song data.

In some embodiments, a hybrid process can combine conventional song fingerprinting and the mechanisms described herein, FIG. 9 shows an example 900 of such a hybrid process that can be used to identify similar songs based on a query song. For example, a user can record a portion of a query song for identification using a computing device at 902. At 904, a fingerprinting process can be performed on portion 902 to create a fingerprint that can be used for finding close matches to a query song. Audio fingerprinting is generally known to those skilled in the art and will not be described in detail herein.

At 906, a database of fingerprint data for reference songs (which can be similar to database 112 of FIG. 1) can be searched using any suitable fingerprint matching techniques to find a matching reference song. Such a database of fingerprint data can contain fingerprint data for reference songs, metadata associated with the reference songs, a reference song vector created using the mechanisms described herein (e.g., using process 200 of FIG. 2A) for each reference song, and any other suitable data related to the reference songs.

At 908, it can be determined if there is a matching reference song in the database of reference song fingerprint data based on the search conducted at 906. If a matching reference song is found (“YES” at 908), process 900 can proceed to 91.0.

At 910, it can be determined whether the matching song is identified as a known cover song (e.g., a song for which a cover song identification process has previously been performed). If the query song is identified as a known cover song (“YES” at 910), process 900 can proceed to 912, where a list of similar songs that have previously been identified can be returned. Otherwise, if the query song is identified as not being a known cover song (“NO” at 910), process 900 can proceed to 914.

At 914, a reference song vector can be retrieved for the reference song that was identified as matching the query song at 908 to be used as a query song vector in a process for identifying similar songs in accordance with the mechanisms described herein.

Returning to 908, if a matching song is not found in the database of reference song fingerprint data (“NO” at 908), process 900 can proceed to 916 where a query song vector can be created based on the query song (or portion of the query song) 902 in accordance with the mechanisms described herein. For example, a query song vector can be created in accordance with process 250 of FIG. 2B.

At 918, a query song vector which has been either retrieved at 914 or created at 916 can be compared to reference song vectors to determine similar songs, for example, in accordance with 260 of process 250 of FIG. 2B.

At 920, a list of similar songs can be provided in accordance with process 100 of FIG. 1 and/or process 250 of FIG. 2B (which can include an empty list, as described above). It should be noted that after identifying a previously unknown query song as being similar to other songs in the reference song database, the query song can be added to the database in association with the vector, a list of similar songs, and any other suitable information, such as fingerprint data of the previously unknown song.

Process 900 can reduce the amount of processing required to identify similar songs when a query song is a song that has already been processed to create a vector and/or has already been compared to other songs in the database to identify similar songs.

FIGS. 10-16 show an example of processes for extracting beat synchronized chroma vectors from a query song 102 that can be used, at least, with processes 100, 200, 300, 400 and 600, in accordance with some embodiments. Processes for extracting beat-synchronized chroma vectors from a query song are also described in U.S. Pat. No. 7,812,241, issued Oct. 12, 2010, which is hereby incorporated by reference herein in its entirety.

In accordance with some embodiments, in order to track beats for extracting and calculating chroma vectors, all or a portion of a song can be converted into an onset strength envelope O(t) 10.16 as illustrated in process 1000 in FIG. 10. As part of this process, the song (or portion of the song) 102 can be sampled or re-sampled (e.g., at 8 kHz or any other suitable rate) at 1002 and then the spectrogram of the short-term Fourier transform (STFT) calculated for time intervals in the song (e.g., using 32 ms windows and 4 ms advance between, frames or any other suitable window and advance) at 1004. An approximate auditory representation of the song can then be formed at 1006 by mapping to 40 Mel frequency bands (or any other suitable number of bands) to balance the perceptual importance of each frequency band. This can be accomplished, for example, by calculating each Mel bin as a weighted average of the FFT bins ranging from the center frequencies of the two adjacent Mel bins, with linear weighting to give a triangular weighting window. The Mel spectrogram can then be converted to dB at 1008, and the first-order difference along time can be calculated for each band at 1010. Then, at 1012, negative values in the first-order differences can be set to zero (half-wave rectification), and the remaining, positive differences can be summed across all of the frequency bands. The summed differences can then be passed through a high-pass filter (e.g., with a cutoff around 0.4 Hz) and smoothed (e.g., by convolving with a Gaussian envelope about 20 ms wide) at 1014. This gives a one-dimensional onset strength envelope 1016 as a function of time (e.g., O(t)) that responds to proportional increase in energy summed across approximately auditory frequency bands.

In some embodiments, the onset envelope for each musical excerpt can then be normalized by dividing by its standard deviation.

FIG. 11 shows an example of an STFT spectrogram 1100, Mel spectrogram 1102, and onset strength envelope 1104 for a brief example of singing plus guitar. Peaks in the onset envelope 1104 correspond to times when there are significant energy onsets across multiple bands in the signal. Vertical bars (e.g., 1106 and 1108) in the onset, strength envelope 1104 indicate beat times.

In some embodiments, a tempo estimate τₚ for the song (or portion of the song) can next be calculated using process 1200 as illustrated in FIG. 12. Given an onset strength envelope O(t) 1016, autocorrelation can be used to reveal, any regular, periodic structure in the envelope. For example, autocorrelation can be performed at 1202 to calculate the inner product of the envelope with delayed versions of itself. For delays that succeed in lining up many of the peaks, a large correlation can occur. For example, such an autocorrelation can be represented as:

$${\sum }_{t}^{ } O ( t ) O ( t - τ ) \qquad ( 3 )$$

Because there can be large correlations at various integer multiples of a basic period (e.g., as the peaks line up with the peaks that occur two or more beats later), it can be difficult to choose a single best peak among many correlation peaks of comparable magnitude. However, human tempo perception (as might be examined by asking subjects to tap along in time to a piece of music) is known to have a bias towards 120 beats per minute (BPM). Therefore, in some embodiments, a perceptual weighting window can be applied, at 1204 to the raw autocorrelation to down-weight periodicity peaks that are far from this bias. For example, such a perceptual weighting window W(τ) can be expressed as a Gaussian weighting function on a log-time axis, such as:

$$W ( τ ) = exp \{ - \frac{1}{2} {( \frac{{log}_{2} τ / {τ}_{0}}{{σ}_{τ}} )}^{2} \} \qquad ( 4 )$$

where τ₀ is the center of the tempo period bias (e.g., 0.5 s corresponding to 120 BPM, or any other suitable value), and σ_{τ} controls the width of the weighting curve and is expressed in octaves (e.g., 1.4 octaves or any other suitable number).

By applying this perceptual weighting window W(τ) to the autocorrelation above, a tempo period strength 1206 can be represented as:

$$TPS ( τ ) = W ( τ ) {\sum }_{t}^{ } O ( t ) O ( t - τ ) \qquad ( 5 )$$

Tempo period strength 1206, for any given period r, can be indicative of the likelihood of a human choosing that period as the underlying tempo of the input sound. A primary tempo period estimate τₚ 1210 can therefore be determined at 1208 by identifying the t for which TPS(τ) is largest.

FIG. 13 illustrates examples of part of an onset strength envelope 1302, a raw autocorrelation 1304, and a windowed autocorrelation (TPS) 1306 for the example of FIG. 11. The primary tempo period estimate τₚ 1210 is also illustrated.

In some embodiments, rather than simply choosing the largest peak in the base TPS, a process 1400 of FIG. 14 can be used to determine τₚ. As shown, two further functions can be calculated at 1402 and 1404 by re-sampling TPS to one-half and one-third, respectively, of its original length, adding this to the original TPS, then choosing the largest peak across both of these new sequences as shown below:

TPS2(τ₂)=TPS(τ₂)+0.5TPS(2τ₂)+0.25TPS(2τ₂−1)+0.25TPS(2τ₂+1) (6)

TPS3(τ₃)=TPS(τ₃)+0.33TPS(3τ₃)+0.33TPS(3τ₃−1)+0.33TPS(3τ₃+1) (7)

Whichever sequence (6) or (7) results in a larger peak value TPS2(τ₂) or TPS3(τ₃) determines at 1406 whether the tempo is considered duple 1408 or triple 1410, respectively. The value of τ₂ or τ₃ corresponding to the larger peak value is then treated as the faster target tempo metrical level at 1412 or 1414, with one-half or one-third of that value as the adjacent metrical level at 1416 or 1418. TPS can then be calculated twice using the faster target tempo metrical level and adjacent metrical level using equation (5) at 1420. In some embodiments, an σₜ of 0.9 octaves (or any other suitable value) can be used instead of an τ_{τ} of 1.4 octaves in performing the calculations of equation (5). The larger value of these two TPS values can then be used at 1422 to indicate that the faster target tempo metrical level or the adjacent metrical level respectively, is the primary tempo period estimate τₚ 1210.

Using the onset strength envelope and the tempo estimate, a sequence of beat times that correspond to perceived onsets in the audio signal and constitute a regular, rhythmic pattern can be generated using process 1500 as illustrated in connection with FIG. 15 using the following equation:

$$C ( \{ {t}_{i} \} ) = {\sum }_{i = 1}^{N} O ( {t}_{i} ) + α {\sum }_{i = 2}^{N} F ( {t}_{i} - {t}_{i - 1} , {τ}_{p} ) \qquad ( 8 )$$

where {tᵢ} is the sequence of N beat instants, O(t) is the onset strength envelope, α is a weighting to balance the importance of the two terms (e.g., α can be 400 or any other suitable value), and F(Δt, τₚ) is a function that measures the consistency between an inter-beat interval Δt and the ideal beat spacing τₚ defined by the target tempo. For example, a simple squared-error function applied to the log-ratio of actual and ideal time spacing can be used for F(Δt, τₚ):

$$F ( Δ t , τ ) = - {( log \frac{Δ t}{τ} )}^{2} \qquad ( 9 )$$

which takes a maximum value of 0 when Δt=τ, becomes increasingly negative for larger deviations, and is symmetric on a log-time axis so that F(kτ,τ)=F(τ/k,τ).

A property of the objective function C(t) is that the best-scoring time sequence can be assembled recursively to calculate the best possible score C*(f) of all sequences that end at time t. The recursive relation can be defined as:

$$C * ( t ) = O ( t ) + {max}_{τ = 0 … t - 1} \{ α F ( t - τ , {τ}_{p} ) + C * ( τ ) \} \qquad ( 10 )$$

This equation is based on the observation that the best score for time t is the local onset strength, plus the best score to the preceding beat time τ that maximizes the sum of that best score and the transition cost from that time. While calculating C*, the actual preceding beat time that gave the best score can also be recorded as:

$$P * ( t ) = arg {max}_{τ = 0 … t - 1} \{ α F ( t - τ , {τ}_{p} ) + C * ( τ ) \} \qquad ( 11 )$$

In some embodiments, a limited range of τ can be searched instead of the full range because the rapidly growing penalty term F will make it unlikely that the best predecessor time lies far from t−τₚ. Thus, a search can be limited to τ=t−2 τₚ . . . t−τₚ/2 as follows:

$$\begin{matrix}C * ( t ) = O ( t ) + {max}_{τ = t - 2 {τ}_{p} … t - {τ}_{p} / 2} \{ α F ( t - τ , {τ}_{p} ) + C * ( τ ) \} & ( {10}^{′} ) \\ P * ( t ) = arg {max}_{τ = t - 2 {τ}_{p} … t - {τ}_{p} / 2} \{ α F ( t - τ , {τ}_{p} ) + C * ( τ ) \} & ( {11}^{′} )\end{matrix}$$

To find the set of beat times that optimize the objective function for a given onset envelope, C*(t) and P*(t) can be calculated at 1504 for every time starting from the beginning of the range zero at 1502 via 1506. The largest value of C* (which will typically be within τₚ of the end of the time range) can be identified at 1508. This largest value of C* is the final beat instant t_{N}—where N, the total number of beats, is still unknown at this point. The beats leading up to C* can be identified by back tracing via P* at 1510, finding the preceding beat time t_{N-1}=P*(t_{N}), and progressively working backwards via 1512 until the beginning of the song (or portion of a song) is reached. This produces the entire optimal beat sequence {tᵢ}* 1514.

In order to accommodate slowly varying tempos, τₚ can be updated dynamically during the progressive calculation of C*(t) and P*(t). For instance, τₚ(t) can be set to a weighted average (e.g., so that times further in the past have progressively less weight) of the best inter-beat-intervals found in the max search for times around t. For example, as C*(t) and P*(t) are calculated at 1504, τₚ(t) can be calculated as:

τₚ(t)=η(t−P*(t))+(1−η)τₚ(P*(t)) (12)

where η is a smoothing constant having a value between 0 and 1 (e.g., 0.1 or any other suitable value) that is based on how quickly the tempo can change. During the subsequent calculation of C*(t+1), the term F(t−τ, τₚ) can be replaced with F(t−τ, τₚ(τ)) to take into account the new local tempo estimate.

In order to accommodate several abrupt changes in tempo, several different τₚ values can be used in calculating C*( ) and P*( ) in some embodiments, in some of these embodiments, a penalty factor can be included in the calculations of C*( ) and P*( ) to down-weight calculations that favor frequent shifts between tempo. For example, a number of different tempos can be used in parallel to add a second dimension to C*( ) and P*( ) to find the best sequence ending at time t and with a particular tempo τₚᵢ. For example, C*( ) and P*( ) can be represented as:

$$\begin{matrix}C * ( t , {τ}_{pi} ) = O ( t ) + {max}_{τ = 0 … t - 1} \{ α F ( t - τ , {τ}_{pi} ) + C * ( τ ) \} & ( {10}^{″} ) \\ P * ( t , {τ}_{pi} ) = arg {max}_{τ = 0 … t - 1} \{ α F ( t - τ , {τ}_{pi} ) + C * ( τ ) \} & ( {11}^{″} )\end{matrix}$$

This approach is able to find an optimal spacing of beats even in intervals where there is no acoustic evidence of any beats. This “filling in” emerges naturally from the back trace and may be beneficial in cases in which music contains silence or long sustained notes.

Using the optimal beat sequence {tᵢ}*, the song (or a portion of the song) can next be used to generate a single feature vector per beat as beat-level descriptors, in accordance with 1106 of FIG. 11. These beat-level descriptors can be used to represent both the dominant note (typically melody) and the broad harmonic accompaniment in the song (or portion of the song) (e.g., when using chroma features as described below).

In some embodiments, beat-level descriptors are generated as the intensity associated with each of 12 semitones (e.g., piano keys) within an octave formed by folding all octaves together (e.g., putting the intensity of semitone A across all octaves in the same semitone bin A, putting the intensity of semitone B across all octaves in the same semitone bin B, putting the intensity of semitone C across all octaves in the same semitone bin C, etc.).

In generating these beat-level descriptors, phase-derivatives (instantaneous frequencies) of FFT bins can be used both to identify strong tonal components in the spectrum (indicated by spectrally adjacent bins with close instantaneous frequencies) and to get a higher-resolution estimate of the underlying frequency. For example, a 1024 point Fourier transform can be applied to 10 seconds of the song (or the portion of the song) sampled (or re-sampled) at 11 kHz with 93 ms overlapping windows advanced by 10 ms. This results in 51.3 frequency bins per FFT window and 1000 FIT windows.

To reduce these 513 frequency bins over each of 1000 windows to 12 (for example) chroma bins per beat, the 513 frequency bins can first be reduced to 12 chroma bins. This can be done by removing non-tonal peaks by keeping only bins where the instantaneous frequency is within 25% (or any other suitable value) over three (or any other suitable number) adjacent bins; estimating the frequency that each energy peak relates to from the energy peak's instantaneous frequency; applying a perceptual weighting function to the frequency estimates so frequencies closest to a given frequency (e.g., 400 Hz) have the strongest contribution to the chroma vector; and frequencies below a lower frequency (e.g. 100 Hz, 2 octaves below the given frequency, or any other suitable value) or above an upper frequency (e.g., 1600 Hz, 2 octaves above the given frequency, or any other suitable value) are strongly down-weighted; and sum up all the weighted frequency components by putting their resultant magnitude into the chroma bin with the nearest frequency.

As mentioned above, in some embodiments, each chroma bin can correspond to the same semitone in all octaves. Thus, each chroma bin can correspond to multiple frequencies (i.e., the particular semitones of the different octaves). In some embodiments, the different frequencies (fᵢ) associated with each chroma bin i can be calculated by applying the following formula to different values of r:

fᵢ=f₀*2^{r+(i/N)} (13)

where r is an integer value representing the octave relative to f₀ for which the specific frequency fᵢ is to be determined (e.g., r=−1 indicates to determine fᵢ for the octave immediately below 440 Hz), N is the total number of chroma bins (e.g., 12 in this example), and f₀ is the tuning center of the set of chroma bins (e.g., 440 Hz or any other suitable value).

Once there are 12 chroma bins over 1000 windows, in the example above, the 1000 windows can be associated with corresponding beats, and then each of the windows for a beat combined to provide a total of 12 chroma bins per beat. The windows for a beat can be combined, in some embodiments, by averaging each chroma bin i across all of the windows associated with a beat. In some embodiments, the windows for a beat can be combined by taking the largest value or the median value of each chroma bin i across all of the windows associated with a beat. In some embodiments, the windows for a beat can be combined by taking the N-th root of the average of the values, raised to the N-th power, for each chroma bin i across all of the windows associated with a beat.

In some embodiments, the Fourier transform can be weighted (e.g., using Gaussian weighting) to emphasize energy a couple of octaves (e.g., around two with a Gaussian half-width of 1 octave) above and below 400 Hz.

In some embodiments, instead of using a phase-derivative within FFT bins in order to generate beat-level descriptors as chroma bins, the STFT bins calculated in determining the onset strength envelope O(t) can be mapped directly to chroma bins by selecting spectral peaks. For example, the magnitude of each FFT bin can be compared with, the magnitudes of neighboring bins to determine if the bin is larger. The magnitudes of the non-larger bins can be set to zero, and a matrix containing the FFT bins can be multiplied by a matrix of weights that map each FFT bin to a corresponding chroma bin. This results in having 12 chroma bins per each of the FFT windows calculated in determining the onset strength envelope. These 12 bins per window can then be combined to provide 12 bins per beat in a similar manner as described above for the phase-derivative-within-FFT-bins approach to generating beat-level descriptors.

In some embodiments, the mapping of frequencies to chroma bins can be adjusted for each song (or portion of a song) by up to ±0.5 semitones (or any other suitable value) by making the single strongest frequency peak from a long FFT window (e.g., 10 seconds or any other suitable value) of that song (or portion of that song) line up with a chroma bin center.

In some embodiments, the magnitude of the chroma bins can be compressed by applying a square root function to the magnitude to improve performance of the correlation between songs.

In some embodiments, each chroma bin can be normalized to have zero mean and unit variance within each dimension (i.e., the chroma bin dimension and the beat dimension). In some embodiments, the chroma bins can also be high-pass filtered in the time dimension to emphasize changes. For example, a first-order high-pass filter with a 3 dB cutoff at around 0.1 radians/sample can be used.

In some embodiments, in addition to the beat-level descriptors described above for each beat (e.g., 12 chroma bins), other beat-level descriptors can additionally be generated and used in comparing songs (or portions of songs). For example, such other beat-level descriptors can include the standard deviation across the windows of beat-level descriptors within a beat, and/or the slope of a straight-line approximation to the time-sequence of values of beat-level descriptors for each window within a beat.

In some of these embodiments, only components of the song (or portion of the song) up to 1 kHz are used in forming the beat-level descriptors. In other embodiments, only components of the song (or portion of the song) up to 2 kHz are used in forming the beat-level descriptors.

The lower two panes 1600 and 1602 of FIG. 16 show beat-level descriptors as chroma bins before and after averaging into beat-length segments.

Accordingly, methods, systems, and media for identifying similar songs using two-dimensional Fourier transform magnitudes are provided.

In some embodiments, any suitable computer readable media can be used for storing instructions for performing the functions and/or processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

It should be noted that, as used herein, the term mechanism can encompass hardware, software, firmware, a method, a system, a non-transitory computer readable medium, or any suitable combination thereof.

It should be understood that the above described steps of the processes of FIGS. 1-4, 6, 8-10, 12, 14 and 15 can be executed or performed in any order or sequence not limited to the order and sequence shown and described in the figures. Also, some of the above steps of the processes of FIGS. 1-4, 6, 8-10, 12, 14 and 15 can be executed or performed substantially simultaneously where appropriate or in parallel to reduce latency and processing times.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

1. A method for identifying a similar song from a query song, the method comprising:
identifying, using at least one hardware processor, a query song vector for the query song, wherein the query song vector is indicative of a two-dimensional Fourier transform based on the query song;
identifying a plurality of reference song vectors that each correspond to one of a plurality of reference songs, wherein each of the plurality of reference song vectors is indicative of a two-dimensional Fourier transform created based on the corresponding reference song;
determining a distance between the query song vector and each of the plurality of reference song vectors;
generating an indication that a reference song corresponding to a reference song vector with a shortest distance to the query song vector is a similar song to the query song.

2. The method of claim 1, wherein identifying a vector further comprises:
generating a beat-synchronized chroma matrix of a plurality of chroma vectors each having a plurality of chroma bins for a portion of a song;
generating one or more two-dimensional Fourier transform patches based on the beat-synchronized chroma matrix;
calculating one or more principal components using a principal component analysis based on the one or more two-dimensional Fourier transform patches; and
calculating the vector based on values of the one or more principal components.

3. The method of claim 2, further comprising raising a value in each of the chroma bins by an exponent.

4. The method of claim 3, wherein the exponent is chosen from a range of 0.25 to 3.

5. The method of claim 2, wherein each of the one or more two-dimensional Fourier transform patches is based on a patch of the beat-synchronized chroma matrix of a particular length.

6. The method of claim 5, wherein the beat-synchronized chroma matrix patch has a size defined by the particular length and the number of chroma bins in each chroma vector and has a total number of chroma bins equal to the particular length times the number of chroma bins in each chroma vector, and wherein the two-dimensional Fourier transform patch has a number of components equal to the number of chroma bins in the beat-synchronized chroma patch and is the same size as the beat-synchronized chroma matrix patch upon which it is based.

7. The method of claim 6, further comprising:
determining magnitude components of the one or more two-dimensional Fourier transform patches and generating two-dimensional Fourier transform magnitude patches based on the magnitudes;
generating a median two-dimensional Fourier transform magnitude patch based on a median of the magnitude components at each position in the two-dimensional Fourier transform magnitude patches; and
wherein the principal component analysis is performed based on values of the median two-dimensional Fourier transform magnitude patch.

8. The method of claim 2, wherein the vector is based on a subset of the calculated principal components.

9. The method of claim 8, wherein the vector is based on a predetermined number of the first principal components, wherein the predetermined number is chosen from a range often to two hundred principal components.

10. The method of claim 1, wherein the distance is a Euclidian distance.

11. The method of claim 1, wherein identifying a vector further comprises receiving a vector from a server.

12. A system for identifying a similar song from a query song, the system comprising:
a hardware processor configured to:
identify a query song vector for the query song, wherein the query song vector is indicative of a two-dimensional Fourier transform based on the query song;
identify a plurality of reference song vectors that each correspond to one of a plurality of reference songs, wherein each of the plurality of reference song vectors is indicative of a two-dimensional Fourier transform created based on the corresponding reference song;
determine a distance between the query song vector and each of the plurality of reference song vectors;
generate an indication that a reference song corresponding to a reference song vector with a shortest distance to the query song vector is a similar song to the query song.

13. The system of claim 12, wherein the hardware processor is further configured to:
generate a beat-synchronized chroma matrix of a plurality of chroma vectors each, having a plurality of chroma bins for a portion of a song;
generate one or more two-dimensional Fourier transform patches based on the beat-synchronized chroma matrix;
calculate one or more principal components using a principal component analysis based on the one or more two-dimensional Fourier transform patches; and
calculate the vector based on values of the one or more principal components.

14. The system of claim 13, wherein the hardware processor is further configured to raise a value in each of the chroma bins by an exponent.

15. The system of claim 14, wherein the exponent is chosen from a range of 0.25 to 3.

16. The system of claim 13, wherein each, of the one or more two-dimensional Fourier transform patches is based on a patch of the beat-synchronized chroma matrix of a particular length.

17. The system of claim 16, wherein the beat-synchronized chroma matrix patch has a size defined by the particular length and the number of chroma bins in each chroma vector and has a total number of chroma bins equal to the particular length times the number of chroma bins in each chroma vector, and wherein the two-dimensional Fourier transform patch has a number of components equal to the number of chroma bins in the beat-synchronized chroma patch and is the same size as the beat-synchronized chroma matrix patch upon which it is based.

18. The system of claim 17, wherein the hardware processor is further configured to:
determine magnitude components of the one or more two-dimensional Fourier transform patches and generating two-dimensional Fourier transform magnitude patches based on the magnitudes;
generate a median two-dimensional Fourier transform magnitude patch based on a median of the magnitude components at each position in the two-dimensional Fourier transform magnitude patches: and
wherein the principal component analysis is performed based on values of the median two-dimensional Fourier transform magnitude patch.

19. The system of claim 13, wherein the vector is based on a subset of the calculated principal components.

20. The system of claim 19, wherein the vector is based on a predetermined number of the first principal components, wherein the predetermined number is chosen from a range of ten to two hundred principal components.

21. The system of claim 12, wherein the distance is a Euclidian distance.

22. The system of claim 12, wherein the hardware processor is further configured to receive a vector from a server.

23. A non-transitory computer readable medium containing computer executable instructions that, when executed by a processor, cause the processor to perform a method for identifying a similar song from a query song, the method comprising:
identifying a query song vector for the query song, wherein the query song vector is indicative of a two-dimensional Fourier transform based on the query song;
identifying a plurality of reference song vectors that each correspond to one of a plurality of reference songs, wherein each of the plurality of reference song vectors is indicative of a two-dimensional Fourier transform created based on the corresponding reference song;
determining a distance between the query song vector and each of the plurality of reference song vectors;
generating an indication that a reference song corresponding to a reference song vector with a shortest distance to the query song vector is a similar song to the query song.

24. The non-transitory computer-readable medium of claim 23, wherein identifying a vector further comprises:
generating a beat-synchronized chroma matrix of a plurality of chroma vectors each having a plurality of chroma bins for a portion of a song;
generating one or more two-dimensional Fourier transform patches based on the beat-synchronized chroma, matrix;
calculating one or more principal components using a principal component analysis based on the one or more two-dimensional Fourier transform, patches; and
calculating the vector based on values of the one or more principal components.

25. The non-transitory computer-readable medium of claim 24, wherein the method further comprises raising a value in each of the chroma bins by an exponent.

26. The non-transitory computer-readable medium of claim 25, wherein the exponent is chosen from a range of 0.25 to 3.

27. The non-transitory computer-readable medium of claim 24, wherein each of the one or more two-dimensional Fourier transform patches is based on a patch of the beat-synchronized chroma matrix of a particular length.

28. The non-transitory computer-readable medium of claim 27, wherein the beat-synchronized chroma matrix patch has a size defined by the particular length and the number of chroma bins in each chroma vector and has a total number of chroma bins equal to the particular length times the number of chroma bins in each chroma vector, and wherein the two-dimensional Fourier transform patch has a number of components equal to the number of chroma bins in the beat-synchronized chroma patch and is the same size as the beat-synchronized chroma matrix patch upon which it is based.

29. The non-transitory computer-readable medium of claim 28, wherein the method further comprises:
determining magnitude components of the one or more two-dimensional Fourier transform patches and generating two-dimensional Fourier transform magnitude patches based on the magnitudes;
generating a median two-dimensional Fourier transform magnitude patch based on a median of the magnitude components at each position in the two-dimensional Fourier transform magnitude patches; and
wherein the principal component analysis is performed based on values of the median two-dimensional Fourier transform magnitude patch.

30. The non-transitory computer-readable medium of claim 24, wherein the vector is based on a subset of the calculated principal components.

31. The non-transitory computer-readable medium of claim 30, wherein the vector is based on a predetermined number of the first principal components, wherein the predetermined number is chosen from a range often to two hundred principal components.

32. The non-transitory computer-readable medium of claim 23, wherein the distance is a Euclidian distance.

33. The non-transitory computer-readable medium of claim 23, wherein identifying a vector further comprises receiving a vector from a server.
